(19) United States
(12) Patent Application Publication
(10) Pub. No.: US 2026/0270720 A1
(43) Pub. Date: Sep. 10, 2026

(54) MULTIPART PACKET TRANSMISSION FOR CONTENTION BASED UPLINK COMMUNICATIONS

(71) Applicant: Qualcomm Incorporated, San Diego, CA (US)

(72) Inventors: Raviteja PATCHAVA, San Diego, CA (US); Jing SUN, San Diego, CA (US); Jing JIANG, San Diego, CA (US)

(21) Appl. No.: 19/071,108

(22) Filed: Mar. 5, 2025

(51) Int. Cl. H04W 24/02; H04L 1/00; H04L 5/00; H04W 72/21; H04W 72/231

(52) U.S. Cl. CPC H04W 24/02; H04L 1/0038; H04L 1/0061; H04L 5/0053; H04W 72/21; H04W 72/231

(57) ABSTRACT

Various aspects of the present disclosure generally relate to wireless communication. In some aspects, a user equipment (UE) may receive configuration information indicating resources for multipart uplink packet transmission. The UE may transmit a first part of an uplink packet in accordance with the configuration information, wherein the first part includes control information and a first portion of data of the uplink packet. The UE may selectively transmit a second part of the uplink packet in accordance with the configuration information, wherein the second part includes a second portion of the data of the uplink packet. Numerous other aspects are described.

### FIELD OF THE DISCLOSURE

Aspects of the present disclosure generally relate to wireless communication and specifically relate to techniques, apparatuses, and methods associated with multipart packet transmissions for contention-based uplink communications.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE). The UE may include a processing system. The processing system may include one or more processors and one or more code-storing memories coupled with the one or more processors. The processing system may be configured to cause the UE to receive configuration information indicating resources for multipart uplink packet transmission. The processing system may be configured to cause the UE to transmit a first part of an uplink packet in accordance with the configuration information, wherein the first part includes control information and a first portion of data of the uplink packet. The processing system may be configured to cause the UE to selectively transmit a second part of the uplink packet in accordance with the configuration information, wherein the second part includes a second portion of the data of the uplink packet.

Some aspects described herein relate to a network node. The network node may include a processing system. The processing system may include one or more processors and one or more code-storing memories coupled with the one or more processors. The processing system may be configured to cause the network node to transmit configuration information indicating resources for multipart uplink packet transmission. The processing system may be configured to cause the network node to receive, based on blind decoding in a first set of resources of the resources for multipart uplink packet transmission, a first part of an uplink packet associated with a UE, wherein the first part includes control information and a first portion of data of the uplink packet. The processing system may be configured to cause the network node to selectively receive, based on the control information, a second part of the uplink packet associated with the UE, wherein the second part includes a second portion of the data of the uplink packet.

Some aspects described herein relate to a method of wireless communication performed by a UE. The method may include receiving configuration information indicating resources for multipart uplink packet transmission. The method may include transmitting a first part of an uplink packet in accordance with the configuration information, wherein the first part includes control information and a first portion of data of the uplink packet. The method may include selectively transmitting a second part of the uplink packet in accordance with the configuration information, wherein the second part includes a second portion of the data of the uplink packet.

Some aspects described herein relate to a method of wireless communication performed by a network node. The method may include transmitting configuration information indicating resources for multipart uplink packet transmission. The method may include receiving, based on blind decoding in a first set of resources of the resources for multipart uplink packet transmission, a first part of an uplink packet associated with a UE, wherein the first part includes control information and a first portion of data of the uplink packet. The method may include selectively receiving, based on the control information, a second part of the uplink packet associated with the UE, wherein the second part includes a second portion of the data of the uplink packet.

Some aspects described herein relate to a non-transitory computer-readable medium that stores a set of instructions for wireless communication by a UE. The set of instructions, when executed by one or more processors of the UE, may cause the UE to receive configuration information indicating resources for multipart uplink packet transmission. The set of instructions, when executed by one or more processors of the UE, may cause the UE to transmit a first part of an uplink packet in accordance with the configuration information, wherein the first part includes control information and a first portion of data of the uplink packet. The set of instructions, when executed by one or more processors of the UE, may cause the UE to selectively transmit a second part of the uplink packet in accordance with the configuration information, wherein the second part includes a second portion of the data of the uplink packet.

Some aspects described herein relate to a non-transitory computer-readable medium that stores a set of instructions for wireless communication by a network node. The set of instructions, when executed by one or more processors of the network node, may cause the network node to transmit configuration information indicating resources for multipart uplink packet transmission. The set of instructions, when executed by one or more processors of the network node, may cause the network node to receive, based on blind decoding in a first set of resources of the resources for multipart uplink packet transmission, a first part of an uplink packet associated with a UE, wherein the first part includes control information and a first portion of data of the uplink packet. The set of instructions, when executed by one or more processors of the network node, may cause the network node to selectively receive, based on the control information, a second part of the uplink packet associated with the UE, wherein the second part includes a second portion of the data of the uplink packet.

Some aspects described herein relate to an apparatus for wireless communication. The apparatus may include means for receiving configuration information indicating resources for multipart uplink packet transmission. The apparatus may include means for transmitting a first part of an uplink packet in accordance with the configuration information, wherein the first part includes control information and a first portion of data of the uplink packet. The apparatus may include means for selectively transmitting a second part of the uplink packet in accordance with the configuration information, wherein the second part includes a second portion of the data of the uplink packet.

Some aspects described herein relate to an apparatus for wireless communication. The apparatus may include means for transmitting configuration information indicating resources for multipart uplink packet transmission. The apparatus may include means for receiving, based on blind decoding in a first set of resources of the resources for multipart uplink packet transmission, a first part of an uplink packet associated with a UE, wherein the first part includes control information and a first portion of data of the uplink packet. The apparatus may include means for selectively receiving, based on the control information, a second part of the uplink packet associated with the UE, wherein the second part includes a second portion of the data of the uplink packet.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of configured grant communication.

FIGS. 4A-4C are diagrams illustrating examples associated with multipart packet transmission for contention-based uplink communications.

FIG. 5 is a diagram illustrating an example associated with multipart packet transmission for contention-based uplink communications associated with multiple user equipments (UEs).

FIG. 6 is a diagram illustrating an example associated with multipart packet transmission for contention-based uplink communications using transmissions in different layers in the power domain.

FIG. 7 is a diagram illustrating an example process performed, for example, at a UE or an apparatus of a UE.

FIG. 8 is a diagram illustrating an example process performed, for example, at a network node or an apparatus of a network node.

FIG. 9 is a diagram of an example apparatus for wireless communication.

FIG. 10 is a diagram of an example apparatus for wireless communication.

### DETAILED DESCRIPTION

In a wireless communication network, a network node may configure a user equipment (UE) with resources for transmitting uplink communications to the network node. In some examples, a network node may transmit, to a UE, control signaling (e.g., downlink control information (DCI)) including a dynamic grant that schedules (e.g., allocates resources for) the transmission of an uplink communication by a UE. However, such per-UE uplink scheduling by the network node may result in large downlink control signaling overhead. Accordingly, increasing self-scheduling of uplink communications by UEs may reduce the downlink control signaling overhead for the network node.

In some examples, a network node may configure a UE with a configured grant (CG) for uplink communication. A CG specifies a recurring grant of resources (e.g., physical uplink shared channel (PUSCH) resources) that can be used by the UE for transmission of uplink communications. In some examples, CG enhancements may be used to increase self-scheduling of uplink transmissions by UEs. For example, a network node may configure a UE with multiple CG configurations, and the UE may select one of the CG configurations and use the resources configured therein to transmit an uplink communication. In such examples, how to configure the CG configurations, and if over-provisioning is permitted, may be left for network node implementation. In an example of such self-scheduled uplink communications, the UE may directly choose a resource (e.g., from the multiple CG configurations) for a given payload size and transmit an uplink communication on the chosen resources. However, different UEs may collide on resource usage and cause interference to the uplink communications transmitted by the different UEs, thus degrading the quality of and reliability of the uplink communications. In such examples, only a cyclic redundancy check (CRC) pass can uniquely identify an uplink transmission.

In some examples, UEs in a wireless communication network may be configured to perform contention-based uplink communications. In such examples, a resource pool may be configured for multiple UEs instead of a per-UE configuration. That is, a network node may configure a resource pool and allocate each resource in the resource pool to multiple UEs. The UEs may use contention-based admission control to access the resources in the resource pool to transmit uplink communications. For example, the contention-based uplink transmissions using the resources in the resource pool may be performed similarly to a PUSCH transmission in a two-step random access channel (RACH) procedure, with one difference being that no physical RACH (PRACH) is needed, just a PUSCH transmission, and another difference being that multiple configurations (e.g., possibly overlapping) may be supported to support payload and modulation and coding scheme (MCS) adaptation. In some examples, the network node may control (e.g., via configuration information transmitted to the UEs), the probability of whether a UE can access a resource in the resource pool for an uplink transmission and a size of the resource pool.

In contention-based (e.g., resource pool based) uplink communication, the UE (e.g., the transmitter) may perform admission control and select a resource to use for transmission of an uplink communication with a proper MCS and payload size for the selected resource. However, the behavior of the network node (e.g., the receiver) in contention-based (e.g., resource pool based) uplink communication is more processing heavy than the behavior of the UE. The network node may perform blind channel estimation and decoding for each of the resources in the resource pool. This may result in a high computational cost, processing time, and power consumption, which may render such contention-based uplink communication unfeasible in a wireless communication network with a large number of UEs.

In some examples, a UE may transmit a standalone uplink control information (UCI) indicator prior to transmitting a PUSCH transmission including uplink data. The UE may transmit the UCI indicator using a UCI resource pool, which may be configured in addition to a PUSCH resource pool for the PUSCH transmission. The UCI indicator may indicate a UE identifier (ID), MCS, and payload size associated with the PUSCH transmission. The UCI indicator may also indicate (e.g., explicitly or implicitly) which resource in the PUSCH resource pool is being used for the PUSCH transmission. The network node may first decode the UCI indicator, and then use the MCS, payload size, and resource information (e.g., time/frequency resource information) indicated in the UCI indicator to receive and decode the PUSCH transmission. In this way, the network node may reduce the blind decoding complexity of the PUSCH transmission. However, the transmission of the UCI indicator increases UCI overhead, which may increase latency of uplink communications, particularly for UEs with a small amount (e.g., a few bits) of data to transmit.

Various aspects relate generally to contention-based uplink communications. Some aspects more specifically relate to multipart packet transmission for contention-based uplink communications. In some aspects, a UE may receive (e.g., from a network node) configuration information that indicates resources for multipart uplink packet transmission. For example, the resources for multipart uplink packet transmission may include a first set of resources associated with contention-based transmission of a first part of an uplink packet and a second set of resources associated with contention-based transmission of one or more other parts of an uplink packet. The UE may transmit a first part of an uplink packet in accordance with the configuration information. For example, the UE may transmit the first part of the uplink packet in a first resource from the first set of resources. The first part of the uplink packet may include control information and at least a portion of data of the uplink packet. The UE may selectively transmit a second part of the uplink packet in accordance with the configuration information. In some examples, the UE may transmit, or refrain from transmitting, the second part of the uplink packet based at least in part on a size of the uplink packet. For example, in the case of an uplink packet with a small amount of data (e.g., the size of the uplink packet does not satisfy a threshold), the UE may transmit only the first part and the first part may include all of the data of the uplink packet. In another example, in the case of an uplink packet with a larger amount of data (e.g., the size of the uplink packet satisfies the threshold), the UE may transmit the second part of the uplink part (and possibly one or more other parts in addition to the first and second part). In such examples, the control information may include information associated with decoding the second part (and possibly the one or more other parts). In some examples, the UE may transmit the second part in a second resource from the second set of resources.

Particular aspects of the subject matter described in this disclosure can be implemented to realize one or more of the following potential advantages. In some examples, by the UE being configured resources for multipart uplink packet transmission and the UE transmitting the first part of the uplink packet separately from other parts of the uplink packet, the described techniques can be used to reduced blind decoding performed by a network node. As a result, the computational cost, power consumption, and computational time associated with decoding contention-based uplink communications at the network node may be reduced. In some examples, by enabling the UE to selectively transmit only the first part of the uplink packet including the control information and the data based on a size of the uplink packet, the described techniques reduce UCI overhead as compared with transmission of a separate UCI prior to each uplink data transmission. As a result, latency of uplink communications may be reduced, particularly for UEs with small amounts of data to transmit.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

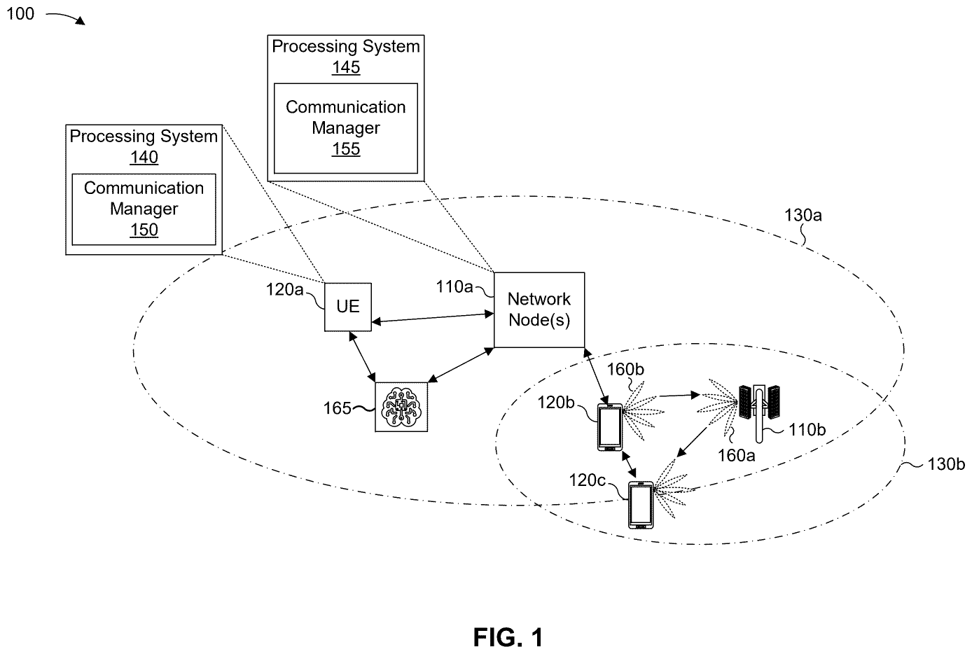

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including an MCS or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit UCI from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include PUSCHs. Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)—reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive configuration information indicating resources for multipart uplink packet transmission; transmit a first part of an uplink packet in accordance with the configuration information, wherein the first part includes control information and a first portion of data of the uplink packet; and selectively transmit a second part of the uplink packet in accordance with the configuration information, wherein the second part includes a second portion of the data of the uplink packet. Additionally, or alternatively, the communication manager 150 may perform one or more other operations described herein.

In some aspects, the network node 110 may include a communication manager 155. As described in more detail elsewhere herein, the communication manager 155 may transmit configuration information indicating resources for multipart uplink packet transmission; receive, based on blind decoding in a first set of resources of the resources for multipart uplink packet transmission, a first part of an uplink packet associated with a UE, wherein the first part includes control information and a first portion of data of the uplink packet; and selectively receive, based on the control information, a second part of the uplink packet associated with the UE, wherein the second part includes a second portion of the data of the uplink packet. Additionally, or alternatively, the communication manager 155 may perform one or more other operations described herein.

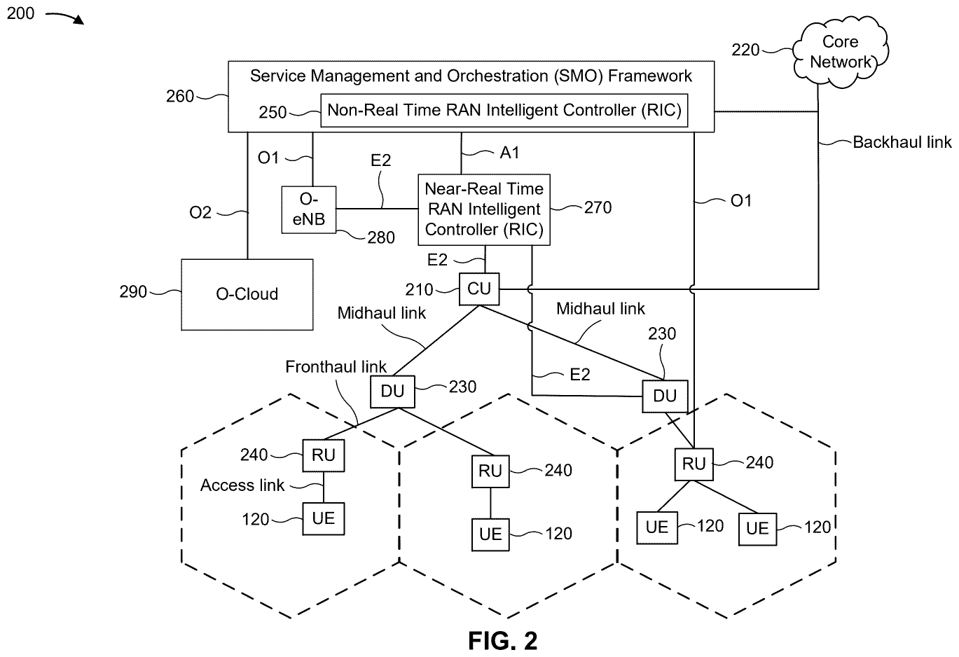

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

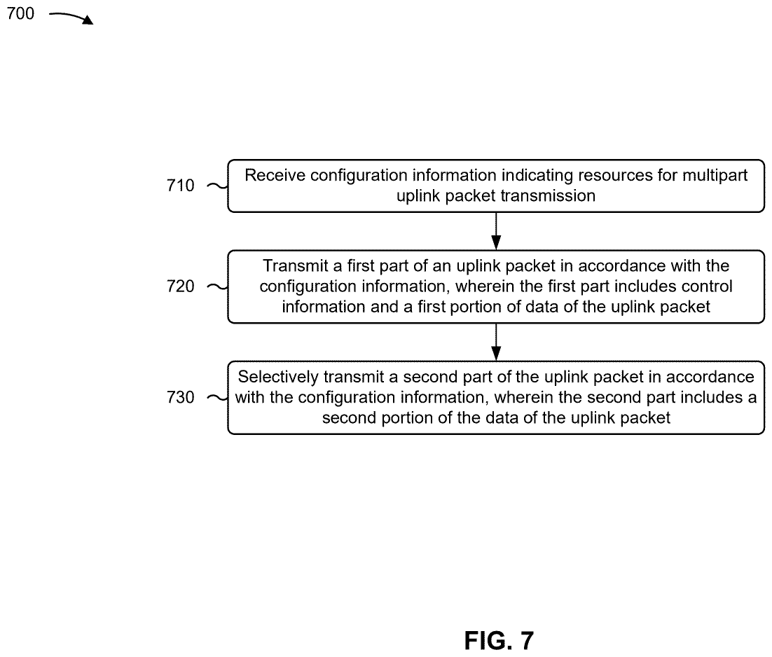

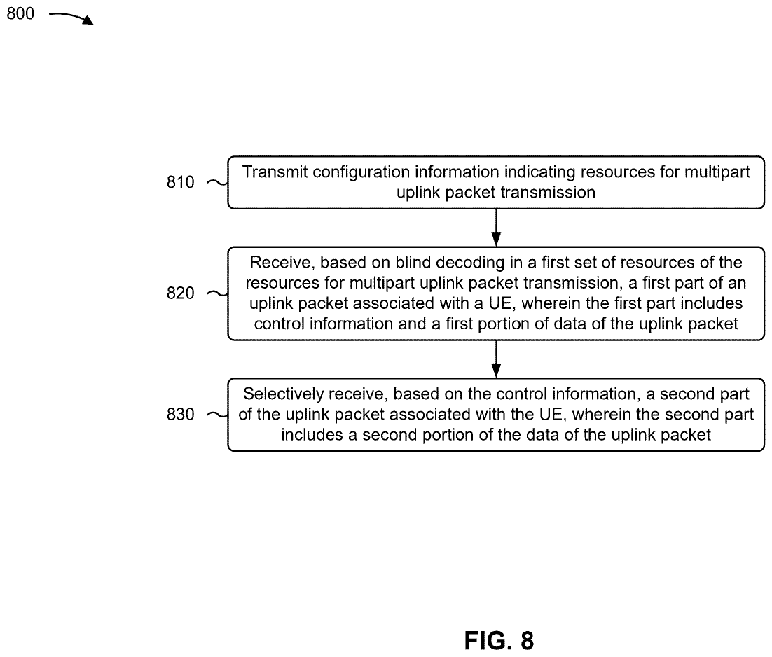

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with multipart packet transmission for contention-based uplink communications, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, or interpreting the instructions, among other examples.

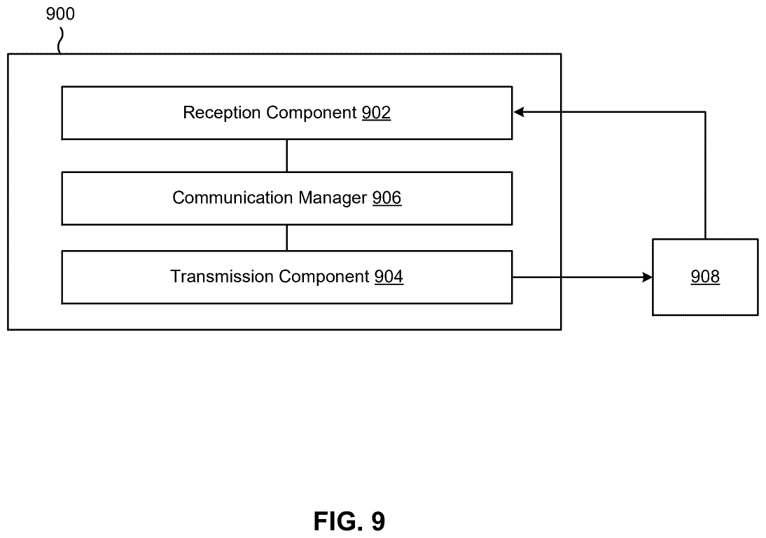

In some aspects, the a UE (e.g., the UE 120) includes means for receiving configuration information indicating resources for multipart uplink packet transmission; means for transmitting a first part of an uplink packet in accordance with the configuration information, wherein the first part includes control information and a first portion of data of the uplink packet; or means for selectively transmitting a second part of the uplink packet in accordance with the configuration information, wherein the second part includes a second portion of the data of the uplink packet. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

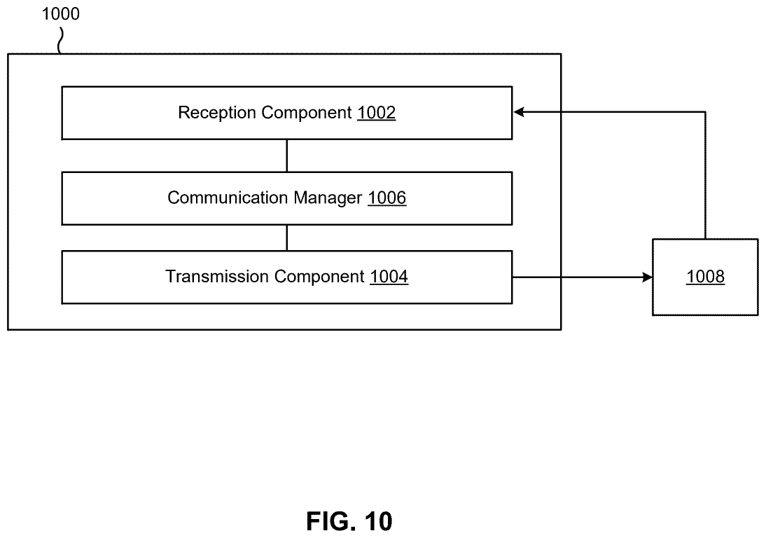

In some aspects, the network node includes means for transmitting configuration information indicating resources for multipart uplink packet transmission; means for receiving, based on blind decoding in a first set of resources of the resources for multipart uplink packet transmission, a first part of an uplink packet associated with a UE, wherein the first part includes control information and a first portion of data of the uplink packet; or means for selectively receiving, based on the control information, a second part of the uplink packet associated with the UE, wherein the second part includes a second portion of the data of the uplink packet. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

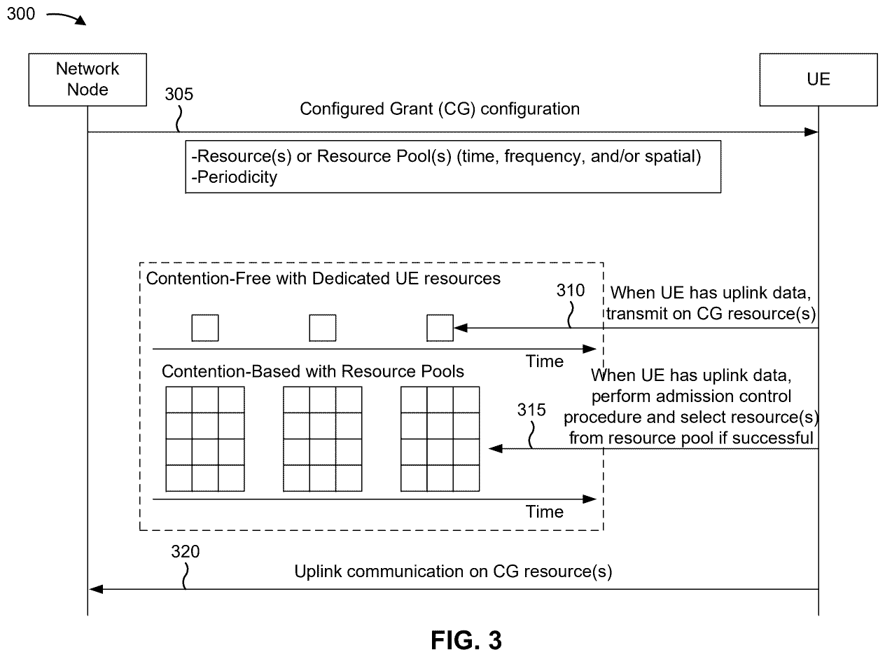

FIG. 3 is a diagram illustrating an example 300 of CG communication. As shown, example 300 includes a network node (e.g., network node 110) and a UE (e.g., UE 120).

As shown in FIG. 3, and by reference number 305, the network node may transmit a CG configuration to the UE. For example, the network node may transmit configuration information (e.g., via RRC signaling, DCI, or a MAC-CE, among other examples) that identifies the CG. In some examples, the configuration information identifying the CG may indicate a resource allocation (e.g., including one or more of time domain resources, frequency domain resources, spatial domain resources, or code domain resources, among other examples) and a periodicity associated with the resource allocation. The CG may identify a resource or set of resources in which the UE is to perform an uplink communication. For example, the CG may identify a resource allocation for a PUSCH of the UE. In some examples, the CG may identify a resource pool or multiple resource pools which may be available for the UE to perform an uplink transmission.

In some examples, the CG configuration received by the UE may configure a contention-free CG with resources dedicated for the UE to transmit uplink communications. In such examples, the CG configuration may indicate a resource allocation dedicated for the UE to use to transmit uplink communications. The CG configuration may also configure the resource allocation for the UE to occur periodically, such that the resource allocation corresponds to periodically occurring transmission time occasions. As shown in FIG. 3, and by reference number 310, when the UE has uplink data to transmit, the UE may transmit the uplink data on the CG resources identified by the CG configuration. For example, the UE may transmit the uplink data in one of the CG uplink occasions identified in the CG configuration using the configured resource allocation.

A CG configuration with regular periodic CG uplink occasions with a dedicated resource allocation for the UE may be convenient for a UE with periodic uplink traffic (e.g., with trivial jitter). The CG configuration may configure the periodicity associated with the resource allocation to associate CG uplink occasions with periodic nominal arrival times at which traffic to be transmitted to the network node is expected to arrive at (or be ready to be transmitted by) the UE. However, the actual arrival times at which the traffic arrives (or is ready to be transmitted) by the UE may be different than the nominal arrival times, and this difference in times is known as jitter. In some examples, traffic jittering may be handled by configuring multiple CGs around the nominal arrival times. In some aspects, multiple opportunities for the UE to transmit the uplink communication may be defined within a CG uplink occasion. The UE may be configured with multiple CG uplink occasions to allow the UE to repeatedly transmit the CG uplink communications and increase the likelihood that the network node receives the communications. In some examples, NR CG uplink may depend on dynamic grant re-transmission. In some examples, to suppress a quantity of dynamic grants, the CG can be configured with blind re-transmissions via multiple repetitions per occasion.

In some examples, CG configurations with dedicated resources allocated per UE may be inefficient. For example, CG configurations with dedicated UE resources for a large number of UEs may result in consumption of an excessive amount of PUSCH resources. In this case, a considerable portion of the PUSCH resources may be inefficiently utilized, which reduces system capacity. For example, when multiple CG configurations for a UE are used for de-jittering, only a subset of CG resources may be effectively utilized. In another example, when multiple transmission opportunities are defined per CG uplink occasion, only one opportunity may be effectively utilized. In yet another example, when a blind repetition scheme is used for re-transmissions, a packet may have been already decoded after the first one or more repetitions (early decoding) such that a remainder of the repetitions are unnecessary. Unlike a downlink case, this type of inefficient consumption of system resources cannot be addressed by scheduling, as the network node does not know exactly when traffic will arrive at the UEs.

In some examples, statistical multiplexing schemes may be used to allocate CG uplink resource access among multiple UEs. Statistical multiplexing of CG uplink communications from multiple UEs may be useful in cases in which there are a high number of UEs associated with somewhat random traffic arrivals at the network node or cases in which a traffic arrival density for traffic arriving at the UEs is time varying, among other examples. For example, statistical multiplexing of CG uplink communications from multiple UEs may be useful for a network deployment, such as an industrial wireless sensor network, with a large capacity of UEs. In such cases, the uplink traffic associated with at least a group of UEs may be delay insensitive.

As shown in FIG. 3, the CG configuration received by the UE may configure a contention-based CG with resource pools that are available for multiple UEs to use to transmit uplink communications. The contention-based CG configuration uses statistical multiplexing to share the resource pools among multiple UEs. A resource pool includes multiple resources (e.g., time domain, frequency domain, spatial domain, code domain, and/or the like) that can be allocated for uplink transmission by the UE. For example, an x-axis of a resource pool may indicate transmission times and the y-axis of the resource pool may indicate resources (e.g., frequency domain resources, spatial domain resources, or code domain resources, among other examples) that can be allocated at each transmission time. In some aspects, the same resource pools may be configured for multiple UEs.

Statistical multiplexing schemes may involve spreading control and overloading control. For example, spreading relates to distributing traffic (as interference to others) into a resource pool. In a specific example, direct spreading CDMA may be utilized in legacy 3G systems. NR systems which rely on an OFDMA network may utilize organized randomized resource selection, in which the network node can identify sources that contribute to collisions in a resource pool and/or local overloading of a resource pool.

Overloading control relates to controlling a level of multiplexing within a stable region. For example, overly aggressive multiplexing may result in an unusable resource pool. Rise over thermal (RoT) based control (in addition to power control) may be utilized in legacy 3G systems. In 3GPP, a central scheduler may be used to assign grants to respective UEs. In 3GPP2, a hybrid approach may be used in which an access network sends a reverse link activity bit to guide autonomous rate selection at respective UEs. Channel busy ratio (CBR) based control may be utilized in NR sidelink. For example, each sidelink UE may autonomously measure CBR and regulate its channel use based at least in part on the measured CBR.

As further shown in FIG. 3, and by reference number 315, for the contention-based CG configuration, when the UE has uplink data to be transmitted, the UE may perform an admission control procedure and may select a resource/resources from the resource pool if the admission control procedure is successful. In some examples, the admission control procedure may include the UE selecting a random number (e.g., between 0 and 1), comparing the random number with a threshold, and determining whether the random number satisfied the threshold. If the random number satisfies the threshold, the admission is successful and the UE may select a resource from the resource pool to transmit the uplink communication.

In some examples, the network node may control the probability of the UE accessing the resource pool by setting and/or adjusting the threshold. For example, the network node may dynamically adjust the threshold to let more or fewer UEs access the resource pool in order to prevent resource collisions. Additionally, or alternatively, the network node may assign different thresholds to be used by different UEs.

In response to the UE determining that the random number satisfies the threshold, the UE may select a resource from the resource pool to transmit the uplink communication. The UE may select the resource from the resource pool using randomized and/or pseudo-randomized resource selection. For example, the UE may use a hashing function based at least in part on a UE identifier, time, or resource pool index to select the resource from the resource pool.

As further shown in FIG. 3, and by reference number 320, the UE may transmit the uplink communication to the network node on the CG resource. For example, the UE may transmit the uplink communication as a PUSCH communication using a resource allocation identified by the CG.

As indicated above, FIG. 3 is provided as an example. Other examples may differ from what is described with respect to FIG. 3.

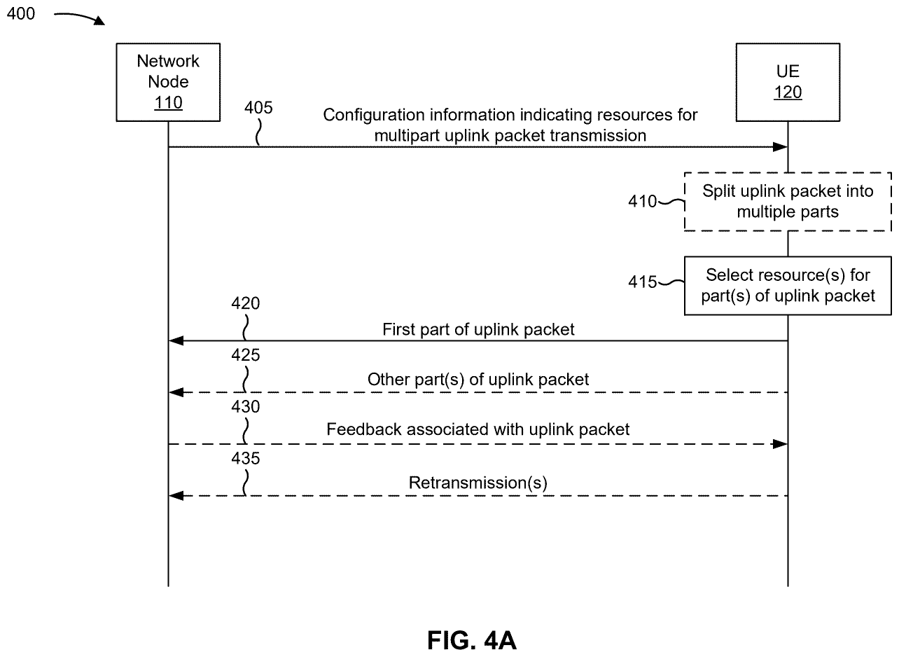

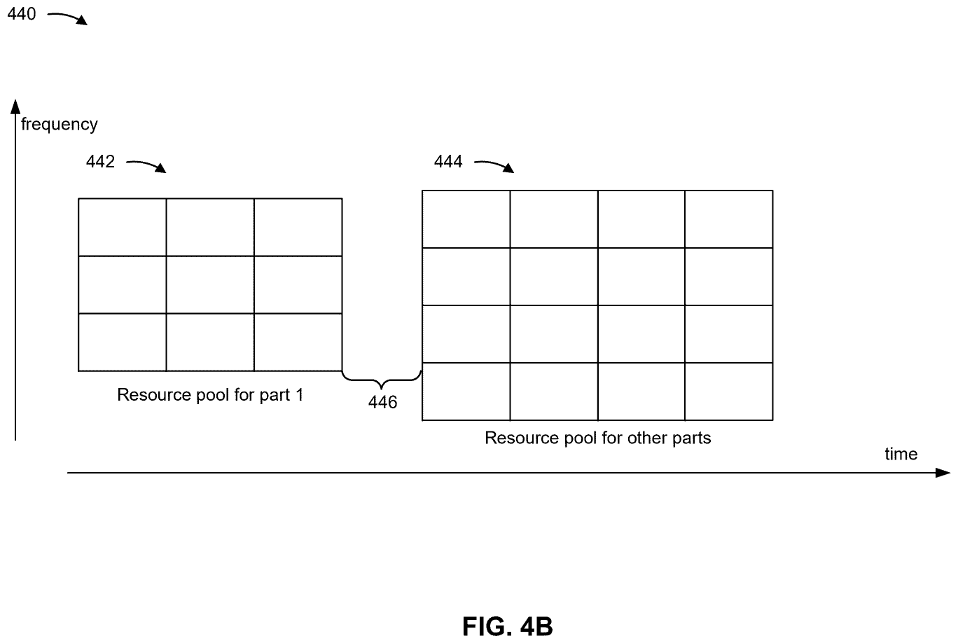

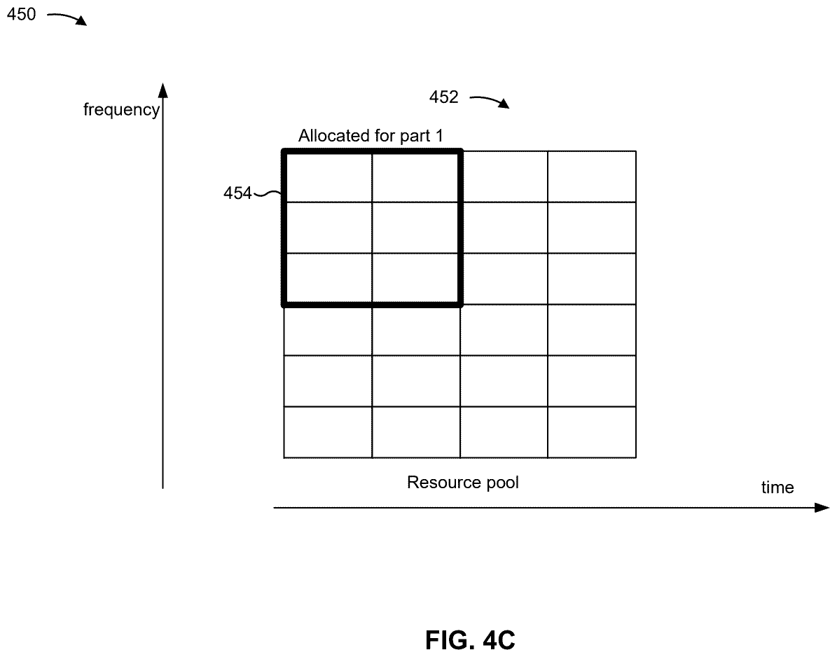

FIGS. 4A-4C are diagrams illustrating examples associated with multipart packet transmission for contention-based uplink communications. As shown in FIG. 4A, example 400 includes communication between a network node 110 and a UE 120. In some aspects, the network node 110 and the UE 120 may be included in a wireless communication network, such as wireless communication network 100. The network node 110 and the UE 120 may communicate via a wireless access link, which may include an uplink and a downlink.

As shown in FIG. 4A, and by reference number 405, the network node 110 may transmit, and the UE 120 may receive, configuration information indicating resources for multipart uplink packet transmission. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

The resource included in the configuration information (e.g., the resources for multipart uplink packet transmission) may be resources (e.g., time and frequency resources, among other examples) for contention-based multipart uplink packet transmission. In some aspects, in contention-based multipart uplink packet transmission, the UE 120 may, in some cases, split an uplink packet to be transmitted by the UE 120 into multiple (e.g., two or more) parts including a first part and one or more other parts (e.g., one or more parts other than the first part). The first part may include control information and data. For example, the data included in the first part may be a first portion of the data included in the uplink packet. The control information included in the first part of the uplink packet may include information associated with decoding the other parts of the uplink packet. For example, the control information may include a frequency domain resource allocation (FDRA), a time domain resource allocation (TDRA), MCS, or DMRS ID, among other examples, for each other part of the uplink packet to be transmitted by the UE 120. The first part of an uplink packet may also be referred to herein as “part 1.” In some aspects, the first part may be a fixed size in resources, and the other parts (e.g., the remaining parts) may be variable in size. For example, the configuration information may indicate (e.g., configure) a fixed size (e.g., a fixed payload size) for the first part of an uplink packet. In some aspects, the MCS or DMRS port choices for the UE 120 to be used for transmitting the first part of an uplink packet may be limited. For example, the configuration information may indicate (e.g., configure) one or more MCSs or DMRS ports that can be used by the UE 120 for transmitting the first part of an uplink packet. In some examples, a lower MCS may be permitted or configured for the transmission of the first part to avoid retransmissions.

In some aspects, the UE 120 may, in some cases, transmit only the first part of an uplink packet. In this case, the UE 120 may refrain from a second part of the uplink packet (e.g., the UE 120 may refrain from transmitting any part other than the first part of the uplink packet). In some aspects, the UE 120 may determine whether to transmit only the first part of an uplink packet or whether to transmit multiple parts of the uplink packet based at least in part on a size of the uplink packet. For example, the UE 120 may transmit multiple parts of the uplink packet in connection with the size of the uplink packet satisfying (e.g., exceeding) a threshold, or the UE 120 may transmit only the first part of the uplink packet in connection with the size of the uplink packet failing to satisfy (e.g., not exceeding) the threshold. In this case, the threshold may be a splitting threshold associated with a payload size of the first part of the uplink packet. For example, the threshold may correspond to an amount of data, of the uplink packet, that can be carried in the first part (e.g., in addition to the control information). For smaller uplink packets, for which all of the data can be carried in the first part, the UE 120 may transmit only the first part. For larger uplink packets, for which all of the data of the uplink packet cannot be carrier in the first part, the UE 120 may split the uplink packet into multiple parts and transmit the multiple parts. In this case, the quantity and size of the parts other than the first part may be based on the size of the uplink packet. In some aspects, the first part of an uplink packet may have its own CRC for individual decoding, and the other parts of the uplink packet may each have their own CRC for individual decoding or may have a common CRC for joint decoding.

In some aspects, the resources indicated in the configuration information (e.g., the resources for multipart uplink packet transmission) may include a first set of resources for transmission of the first part of an uplink packet (e.g., for part 1 transmission) and a second set of resources for transmission of one or more other parts (e.g., other than part 1) of an uplink packet. The first set of resources may be resources for contention-based transmission of the first part of an uplink packet, and the second set of resources may be resources for contention-based transmission of one or more other parts of an uplink packet. The network node 110 may use blind decoding for the first set of resources only (e.g., to receive and decode part 1 of an uplink packet), and then the network node 110 may use the control information included in part 1 to decode the other parts of the uplink packet. In this way, the blind decoding complexity of the other parts of the uplink packet is reduced for the network node 110. In some aspects, the resources for multipart uplink transmission (e.g., the first set of resources and the second set of resources) may be periodic or semi-persistent resources that reoccur with a certain periodicity. For example, the configuration information may indicate the periodicity associated with the resources for multipart uplink transmission (e.g., the first set of resources and the second set of resources). In some aspects, the network node 110 may transmit the configuration information indicating the resources for multipart uplink transmission (e.g., the first set of resources and the second set of resources) to multiple UEs. That is, multiple UEs may be configured with the same resources for multipart uplink transmission. In some examples, the network node 110 may broadcast (e.g., via system information) the configuration information indicating the resources for multipart uplink transmission to all UEs in a cell associated with the network node 110. In some other examples, the network node 110 may transmit the configuration information indicating the resources for multipart uplink transmission to a group of UEs (e.g., a group of UEs that includes the UE 120) to configure the group of UEs with the same resources for multipart uplink transmission.

In some aspects, the configuration information may indicate (e.g., configure) separate resource pools for transmission of the first part of an uplink packet and the transmission of one or more other parts of an uplink packet. In such examples, the first set of resources for part 1 transmission may be included in a first resource pool, and the second set of resources for transmission of one or more other parts may be included in a second resource pool. FIG. 4B illustrates an example 440 of separate resource pools allocated for transmission of the first part of an uplink packet and transmission of other parts of an uplink packet. As shown in FIG. 4B, a first resource pool 442 may be configured (e.g., via the configuration information) for part 1 transmission, and a second resource pool 444 may be configured for transmission of the other parts (e.g., other than part 1) of an uplink packet. The first resource pool 442 indicates a first set of resources (e.g., time and frequency resources) for part 1 transmission, and the second resource pool 444 indicates a second set of resources (e.g., time and frequency resources) for transmission of other parts of an uplink packet. The first resource pool 442 and second resource pool 444 may be separated in the time domain. As shown in FIG. 4B, in some aspects, the first resource pool 442 and the second resource pool 444 may be separated by a time gap 446. The time gap 446 may enable a reduction of a buffer size at the network node 110. For example, the time gap 446 may enable the network node 110 to decode the first part of an uplink packet received via a resource in the first resource pool 442 and then, based on the control information included in the first part, decode one or more other parts of the uplink packet received via respective resources in the second resource pool 444 without buffering all of the received signals in the second resource pool 444.

In some aspects, the network node 110 may allocate (e.g., via the configuration information) the resources in the first resource pool 442 such that a collision probability for the first resource pool 442 is lower than a collision probability for the second resource pool 444. That is, a first collision probability associated with the first resource pool 442 may be less than a second collision probability associated with the second resource pool 444. In some examples, as the number of resources required for part transmission is lower than the number of resources for transmission of other parts, a lower collision probability may be achieved for the first resource pool 442 with a smaller quantity of resources than the second resource pool 444. In some aspects, the resource allocation for the first resource pool 442 may be based at least in part on a blind decoding complexity supported by the network node 110.

In some aspects, the configuration information may indicate (e.g., configure) a resource pool that includes resources for transmission of the first part of an uplink packet and resources for transmission of one or more other parts of an uplink packet. That is, the first set of resources for part 1 transmission and the second set of resources for transmission of one or more other parts may be included in a same resource pool allocation. FIG. 4C shows an example 450 in which resources for transmission of the first part of an uplink packet and resources for transmission of other parts of an uplink packet are allocated in a same resource pool 452. As shown in FIG. 4C, the resource pool 452 includes a subset of resources 454 allocated for part 1 transmission. In this example, only a resource included in the subset of resources 454 may be used by the UE 120 for transmitting the first part of an uplink packet, and the network node 110 may perform blind decoding (e.g., for decoding part 1) only on the subset of resources 454. In some aspects, all of the resources in the resource pool 452 are allocated for transmission of other parts (e.g., other than part 1) of an uplink packet. That is, all of the resources in the resource pool 452, including the subset of resources 454 and other resources in the resource pool 452, may be used by the UE 120 for transmitting other parts (e.g., other than part 1) of an uplink packet. Accordingly, in this example, the first set of resources for transmission of the first part of an uplink packet includes the subset of resources 454 in the resource pool 452, and the second set of resources for transmission of other parts of an uplink packet includes the subset of resources 454 and remaining resources, other than the subset of resources 454, included in the resource pool 452. As a result, the example 450 shown in FIG. 4C may have a higher resource utilization for a low load case, as compared with the example 440 shown in FIG. 4B.

In some aspects, the subset of resources 454 may be allocated in one or more initial OFDM symbols of the resource pool 452 for better timeline processing (e.g., lower buffering) at the network node 110. In some aspects, in a case in which the UE 120 selects a first resource in the subset of resources 454 for transmission of the first part of an uplink packet, and the UE 120 selects respective resources in the resource pool 452 for transmission of one or more other parts of the uplink packet, the UE 120 may select the resources for the one or more other parts at the same time (e.g., in the same OFDM symbol) as the resource selected for the first part or later (e.g., in a later OFDM symbol) than the resource selected for the first part.

In some aspects, the configuration information may configure the UE 120 to transmit the first part of an uplink packet and a second part of the uplink packet via separate layers in a power domain. For example, the configuration information may indicate that the UE 120 is permitted to transmit, in the same resource (e.g., in the first set of resources allocated for part 1 transmission), the first part of the uplink packet via a base layer in the power domain and the second part of the uplink packet via an enhancement layer in the power domain. Such transmission of the first and second parts via different layers in the power domain may be configured together with the configuration of separate resource pools for part 1 transmission and transmission of other parts (e.g., as described in connection with FIG. 4B) or the configuration of resources for part 1 transmission and the resources for transmission of other parts allocated in the same resource pool (e.g., as described in connection with FIG. 4C). In some examples, the configuration information may indicate a splitting ratio for splitting the signal transmitted in a resource between the first part transmitted via the base layer and the second part transmitted via the enhancement layer.

As further shown in FIG. 4A, and by reference number 410, in some aspects, the UE 120 may split an uplink packet to be transmitted by the UE 120 into multiple parts. In some aspects, the UE 120 may determine whether to split the uplink packet into multiple parts based at least in part on the size of the uplink packet. In some examples, the UE 120 may determine whether to split the uplink packet into multiple parts based at least in part on a comparison of the size of the data packet with a threshold. For example, the threshold may be a splitting threshold associated with a payload size of the first part of the uplink packet. In this case, the threshold may correspond to an amount of data, of the uplink packet, that can be carried in the first part (e.g., in addition to the control information).

In some aspects, the UE 120 may split the uplink packet into multiple parts in connection with the size of the uplink packet satisfying (e.g., exceeding) the threshold (e.g., the splitting threshold). In this case, the UE 120 may split the uplink packet into a first part and one or more other parts. Each part of the uplink packet (e.g., of the first part and the one or more other parts) may include a respective portion of the data included in the uplink packet. The first part of the uplink packet may also include control information associated decoding the one or more other parts. For example, the UE 120 may split the packet into the first part, including the control information and a first portion of the data included in the uplink packet, and a second part, including a second portion of the data included in the uplink packet. In some examples, the UE 120 may split the uplink packet into the first part, the second part, and one or more additional parts (e.g., in addition to the first part and the second part).

In some aspects, the UE 120 may refrain from splitting the uplink pack into multiple parts in connection with the size of the uplink packet failing to satisfy (e.g., not exceeding) the threshold (e.g., the splitting threshold). In this case, the UE 120 may generate the first part of the uplink packet without generating any other parts of the uplink packet. In this case, the first part of the uplink packet may include control information (e.g., control information indicating that no other part of the uplink packet is to be transmitted or other control information) and all of the data of the uplink packet.

As further shown in FIG. 4A, and by reference number 415, the UE 120 may select a respective resource for each part of the uplink packet. The UE 120 may select, from the resources for multipart uplink packet transmission indicated in the configuration information, a respective resource for each part of the uplink packet. The UE 120 may select a first resource for transmission of the first part of the uplink packet in accordance with the configuration information. In some aspects, the UE 120 may select the first resource for transmission of the first part of the uplink packet from the first set of resources associated part 1 transmission. For example, the first set of resources may be included in a first resource pool (e.g., the first resource pool 442 shown in FIG. 4B) allocated separately from a second resource pool including resources for transmission of other parts of an uplink packet, or the first set of resources may be included in a subset of resources (e.g., the subset of resources 454 shown in FIG. 4C) of a resource pool that includes resources for transmission of other parts of an uplink packet.

In a case in which the UE 120 splits the uplink packet into multiple parts to be transmitted by the UE 120, the UE 120 may select a resource for transmission of a second part of the uplink packet in accordance with the configuration information. In some aspects, the UE 120 may select a second resource for transmission of the second part of the uplink packet from the second set of resources associated with transmission of one or more other parts (e.g., other than part 1) of an uplink packet. For example, the second set of resources may be included in a second resource pool (e.g., the resource pool 444 shown in FIG. 4B) allocated separately from a first resource pool including resources for part 1 transmission, or the second set of resources may include all resources in a resource pool (e.g., the resource pool 452 shown in FIG. 4C) that includes a subset of resources allocated for part 1 transmission. In such examples, the UE 120 may also select respective resources from the second set of resources for one or additional parts of the uplink packet (e.g., in addition to the first part and the second part).

In some aspects, in a case in which the UE 120 splits the uplink packet into multiple parts to be transmitted by the UE 120, the UE 120 may select to transmit the first part of the uplink packet and at least one other part of the uplink packet in the same resource via different layers in the power domain. For example, the UE 120 may select the first resource, from the first set of resources associated with part 1 transmission, as a resource in which the UE 120 is to transmit the first part of the uplink packet in the base layer and transmit the second part of the uplink packet in the enhancement layer. In such examples, the UE 120 may also select respective resources from the second set of resources for one or additional parts of the uplink packet (e.g., in addition to the first part and the second part). That is, The UE 120 may transmit a portion of the data in other parts of the uplink packet in the enhancement layer of the resources used for part 1, and another portion of the data in the other parts may be transmitted in selected (e.g., randomly selected) separate resources from the resources used for part 1.

In some aspects, in order to select a resource for contention-based transmission of a part of the uplink packet, the UE 120 may first perform admission control to determine whether the UE 120 can access the resource pool including the resources allocated for transmitting the part of the uplink packet. In some aspects, the UE 120 may perform admission control for an uplink resource in the resource pool based at least in part on a random number (denoted as ‘q’) determined by the UE 120 and an admission probability (denoted as ‘p’) set by the network node 110. By setting the admission probability p, the network node 110 can dynamically control the probability of the UE 120 to access the uplink resource in the resource pool. In some examples, in a case in which the configuration information indicates a first resource pool associated with part 1 transmission and a second resource pool associated with transmission of other parts of an uplink packet, the network node 110 may set different admission probabilities for the first and second resource pools. The admission probability p may be a threshold that the UE 120 compares with the random number q. If the random number q satisfies the admission probability threshold p, the admission is successful and the UE 120 can utilize a resource in an occasion of the resource pool to transmit the part of the uplink packet. If the random number does not satisfy the admission probability threshold p, the admission has failed and the UE 120 cannot utilize a resource in the occasion of the resource pool to transmit the part of the uplink packet. For example, the admission probability p may be set as 0≤p≤1 and the random number q may be generated such that 0≤q≤1. The UE 120 may compare the random number q with the admission probability p and determine that admission is successful if q≥p.

In some aspects, q may be randomly generated by the UE 120 from a uniform distribution in a target range (e.g., between 0 and 1). In some aspects, different distributions may be used for determining q in order to weight q to be higher or lower based at least in part on one or more UE-specific parameters, such as a traffic quality of service (QoS) parameter or priority parameter, among other examples. In some examples, q may be a pseudo-random number generated as a function of one or more parameters including a parameter associated with the network node 110 (e.g., a network node ID), a parameter associated with the UE 120 (e.g., a UE ID), a time, a resource pool index, or an MCS parameter, among other examples.

In connection with the UE 120 determining that the UE 120 can access a resource in an occasion of the resource pool, the UE 120 may select a resource in the resource for transmitting the part of the uplink packet. In some aspects, the resource selection may be based at least in part on a UE-specific resource hashing function. The UE-specific resource hashing function may be based at least in part on various factors such as a UE ID, time, or resource pool index, among other examples. Any hashing that results in a random or pseudo-random distribution across the uplink transmission occasion may be used.

As further shown in FIG. 4A, and by reference number 420, the UE 120 may transmit, and the network node 110 may receive, the first part of the uplink packet. The UE 120 may transmit the first part of the uplink packet in a first resource selected for transmitting the first part of the uplink packet. In some aspects, the first resource may be included in the first set of resources associated with part 1 transmission. In some examples, the first resource may be included in a first resource pool (e.g., the first resource pool 442 shown in FIG. 4B) allocated separately from a second resource pool including resources for transmission of other parts of an uplink packet. In some other examples, the first resource may be included in a subset of resources (e.g., the subset of resources 454 shown in FIG. 4C) of a resource pool that includes resources for transmission of other parts of an uplink packet.

In some aspects, the network node 110 may perform blind decoding in the first set of resources associated with part 1 transmission, and the network node 110 may receive and decode the first part of the uplink packet based on the blind decoding in the first set of resources. In some examples, the network node 110 may perform blind decoding in the first resource pool (e.g., the first resource pool 442 shown in FIG. 4B) associated with part 1 transmission, and the network node 110 may refrain from performing blind decoding in the second resource (e.g., the second resource pool 444 shown in FIG. 4B) associated with transmission of other parts of an uplink packet. In some examples, the network node 110 may perform blind decoding in a subset of resources (e.g., the subset of resources 454 shown in FIG. 4C) of a resource pool (e.g., the resource pool 452 shown in FIG. 4C), and the network node 110 may refrain from performing blind decoding in the remaining resources, other than the subset of resources, in the resource pool. In some aspects, the network node 110 may perform blind decoding on the base layer of the resources allocated for part 1 (e.g., the first set of resources). For example, the network node may perform blind decoding on the base layer in the first resource pool 442 shown in FIG. 4B or in the subset of resources 454 shown in FIG. 4C.

The first part of the uplink packet may include control information and at least a portion of the data of the uplink packet. In some aspects, the control information may indicate whether one or more other parts (e.g., other than the first part) of the uplink packet are to be transmitted. For example, the control information may include a binary indication of whether or not at least one other part of the uplink packet is to be transmitted, an indication of a number of other parts of the uplink packet to be transmitted, or an implicit indication of whether one or more parts of the uplink packet or to be transmitted (e.g., the control information may implicitly indicate whether one or more other parts of the uplink packet are to be transmitted by including or not including information associated with decoding the one or more other parts), among other examples. In some aspects, in a case in which one or more other parts (e.g., other than the first part) of the uplink packet are to be transmitted by the UE 120, the control information may indicate the respective resources selected for transmission of the one or more other parts. In some examples, instead of indicating full time and frequency resources for the one or more other parts, the control information may identify a resource for another part by indicating a resource ID associated with a resource pool (e.g., the second resource pool 444 shown in FIG. 4B or the resource pool 452 shown in FIG. 4C). Additionally, or alternatively, in a case in which one or more other parts are to be transmitted by the UE 120, the configuration information may indicate whether another part of the uplink packet (e.g., a second part of the uplink packet) is transmitted in the enhancement layer in the same resource as the first part of the uplink packet. Additionally, or alternatively, in a case in which one or more other parts are to be transmitted by the UE 120, the configuration information may indicate one or more of an MCS, a number of layers, a payload size, or a number of layers for each of the one or more other parts of the uplink packet.

In some aspects, the control information may indicate a UE ID (e.g., a cell radio network temporary identifier (C-RNTI)) associated with the UE 120. For example, the UE ID may be used by the network node 110 for retransmission control in a case in which only part 1 is successfully decoded by the network node 110. In some aspects, in a case in which the UE 120 transmits only the first part of the uplink packet (e.g., the UE 120 refrains from transmitting any part of the uplink packet other than the first part), the control information may indicate that the no other part of the uplink traffic (e.g., no part of the uplink traffic other than the first part) is to be transmitted.

In some aspects, the control information included in the first part of the uplink packet may be UCI based. In such examples, the first part of the uplink packet includes separate UCI (e.g., separate from the data included in a payload of the first part), with its own CRC (e.g., the UCI is associated with a CRC specific to the UCI), that includes the control information. In some other aspects, the control information included in the first part of the uplink packet may be payload (e.g., MAC-CE) based. In such examples, the control information may be embedded as part of the payload (e.g., a MAC-CE payload) in the first part of the uplink packet.

As further shown in FIG. 4A, and by reference number 425, in some aspects, the UE 120 may transmit, and the network node 110 may receive, one or more other parts (e.g., other than the first part) of the uplink packet. In some aspects, the UE 120 may selectively transmit a second part of the uplink packet. For example, the UE 120 may transmit a second part of the uplink packet or refrain from transmitting a second part of the uplink packet based at least in part on the size of the uplink packet, similar to as described above in connection with reference number 410. That is, in a case in which the UE 120 determines to split the packet into multiple parts (e.g., based on the size of the packet packet), the UE 120 may transmit the second part of the uplink packet in the resource selected for the second part of the uplink traffic. In this case, the UE 120 may also transmit one or more additional parts of the uplink packet, in addition to the first part and the second part, in the respective resources selected for the one or more additional parts. In a case in which the UE 120 determines not to split the packet into multiple parts (e.g., based on the size of the uplink packet), the UE 120 may refrain from transmitting a second part of the uplink packet (e.g., the UE 120 may only transmit the first part of the uplink packet).

The network node 110 may selectively receive the second part of the uplink packet based on the control information included in the first part of the uplink packet. The network node 110 may refrain from performing blind decoding in resources other than the first set of resources allocated for part 1 transmission. In a case in which the UE 120 does not transmit the second part of the uplink packet, the control information included in the first part of the uplink packet may indicate that no other part of the uplink packet is to be transmitted by the UE 120. In this case, the network node 110 may refrain from receiving (e.g., refrain from monitoring for or performing blind decoding for) the second part of the uplink packet. In a case in which the UE 120 transmits the second part of the uplink packet, the UE 120 may transmit the second part of the uplink packet in accordance with the control information included in the first part of the uplink packet (e.g., the control information indicating one or more of a selected resource for the second part, an MCS for the second part, a payload size for the second part, or a number of layers for the second part, among other examples). In this case, the network node 110 may receive and decode the second part of the uplink packet based on the control information, included in the first part of the uplink packet, that is associated with the second part of the uplink packet.

As further shown in FIG. 4A, and by reference number 430, in some aspects, the network node 110 may transmit, and the UE 120 may receive, feedback associated with the uplink packet. For example, the feedback may include ACK or NACK (ACK/NACK) feedback associated with the uplink packet. As shown by reference number 435, in some aspects, the UE 120 may transmit, and the network node 110 may receive, one or more retransmissions associated with the uplink packet based at least in part on the feedback associated with the uplink packet.

In some aspects, in a case in which the network node 110 successfully decodes all of parts of the uplink packet transmitted by the UE 120, the network node 110 may transmit, and the UE 120 may receive, a UE-specific ACK indicative of successful decoding of all parts of the uplink packet. In this case, the UE 120 may not transmit (e.g., refrain from transmitting) any retransmissions associated with the uplink packet. In some examples, the network node 110 may transmit the UE-specific ACK to the UE 120 via special DCI scrambled by a user ID or UE ID (e.g., a C-RNTI) associated with the UE 120. In some other examples, the network node 110 may transmit the UE-specific ACK via group common DCI (GC-DCI) with a UE ID associated with the UE 120 indicated in the payload. In such examples, the network node 110 may indicate a hashed version of the UE ID (e.g., instead of the full UE ID) in the payload of the GC-DCI in order to reduce payload size of the GC-DCI. In some other examples, the network node 110 may transmit the UE-specific ACK via GC-DCI including ACK/NACK bits that are mapped to respective resource IDs associated with resources of a resource pool. In such examples, the GC-DCI may indicate the ACK indicative of successful decoding of all parts of uplink packet by indicating ACK bits corresponding to all of the respective resources in which the parts of the uplink packet are transmitted, or the GC-DCI may indicate the ACK indicative of successful decoding of all parts of the uplink packet by indicating an ACK bit corresponding to resource in which the first part of the uplink packet is transmitted (e.g., only if all the parts of the uplink packet are successfully decoded). In some examples in which the GC-DCI including ACK/NACK bits mapped to resource IDs associated with resources of a resource pool is used to indicate the UE-specific ACK, there may be a packet loss for a UE with a weak signal-to-noise ratio (SNR). For example, strong and weak SNR UEs may select the same resources, and the uplink packet for the strong SNR UE may be successfully decoded by the network node 110. In this case, the weak SNR UE may assume, based on the GC-DCI indicating an ACK bit for the resource, that the uplink transmission of the weak SNR UE was successfully decoded.

In some aspects, the UE 120 may transmit multiple parts of the uplink packet, and the network node 110 may successfully decode the first part of the uplink packet (e.g., with the control information included in the payload of part 1) but may not successfully decode at least one other part of the uplink packet. In this case, the network node 110 may transmit, and the UE 120 may receive, feedback indicative of successful decoding of the first part and unsuccessful decoding of a second part. The UE 120, in connection with receiving the feedback indicative of successful decoding of the first part and unsuccessful decoding of the second part, may retransmit the second part. In some examples, the network node 110 may transmit, via special DCI scrambled by a user ID or UE ID (e.g., a C-RNTI) associated with the UE 120 or via GC-DCI with a UE ID associated with the UE 120 indicated in the payload, a NACK indicating information associated with the unsuccessfully decoded part(s) (e.g., the second part) of the uplink packet. In such examples, the network node 110 may indicate, in the special DCI or the GC-DCI, a power ramp to be applied for retransmission. In some other examples, the network node 110 may transmit, to the UE 120 via DCI scrambled by a user ID or UE ID (e.g., a C-RNTI) associated with the UE 120, an explicit retransmission grant which implicitly indicates a NACK for the data included in the unsuccessfully decoded part(s) (e.g., the second part) of the uplink packet. In some other examples, the network node 110 may indicate, via GC-DCI with ACK/NACK bits mapped to resource IDs associated with resources of a resource pool, a NACK for the resource(s) used for transmission of the unsuccessfully decoded part(s) (e.g., the second part) of the uplink packet.

In some aspects, in a case in which the control information in the first part of the uplink packet is included in UCI separate from the payload including the data, the network node 110 may successfully decode the UCI in the first part of the uplink packet but may not successfully decode the data in the first part or at least one other part (e.g., a second part). In this case, the network node 110 may transmit, and the UE 120 may receive, feedback indicative of successful decoding of the control information (e.g., in the UCI) and unsuccessful decoding of data in the first part or at least one other part. The UE 120, in connection with receiving the feedback indicative of successful decoding of the control information and unsuccessful decoding of data in the first part or at least one other part, may retransmit the data in the first part or the at least one other part. In some examples, the network node 110 may transmit, via special DCI scrambled by a user ID or UE ID (e.g., a C-RNTI) associated with the UE 120 or via GC-DCI with a UE ID associated with the UE 120 indicated in the payload, a NACK indicating information associated with the unsuccessfully decoded data in the first or at least one other part of the uplink packet. In such examples, the network node 110 may indicate, in the special DCI or the GC-DCI, a power ramp to be applied for retransmission. In some other examples, the network node 110 may transmit, to the UE 120 via DCI scrambled by a user ID or UE ID (e.g., a C-RNTI) associated with the UE 120, an explicit retransmission grant which implicitly indicates a NACK for the unsuccessfully decoded data in the first or at least one other part of the uplink packet. In some other examples, the network node 110 may indicate, via GC-DCI with ACK/NACK bits mapped to resource IDs associated with resources of a resource pool, a NACK for the resource(s) used for transmission of the first part or the at least one other part of the uplink packet.

In some aspects, in a case in which the network node 110 does not successfully decode the control information in the first part of the uplink packet, the network node 110 may refrain from transmitting any ACK/NACK feedback associated with the uplink packet. In this case, the UE 120 may retransmit the first part of the uplink packet, and the UE 120 may selectively retransmit one or more other parts of the uplink packet (e.g., the UE 120 may retransmit all parts of the uplink packet previously transmitted by the UE 120), in connection with a determination that no ACK/NACK feedback associated with the uplink packet has been received by the UE 120. In this case, the UE 120 may retransmit each part of the uplink packet with a predefined power ramp.

As indicated above, FIGS. 4A-4C are provided as examples. Other examples may differ from what is described with respect to FIGS. 4A-4C.

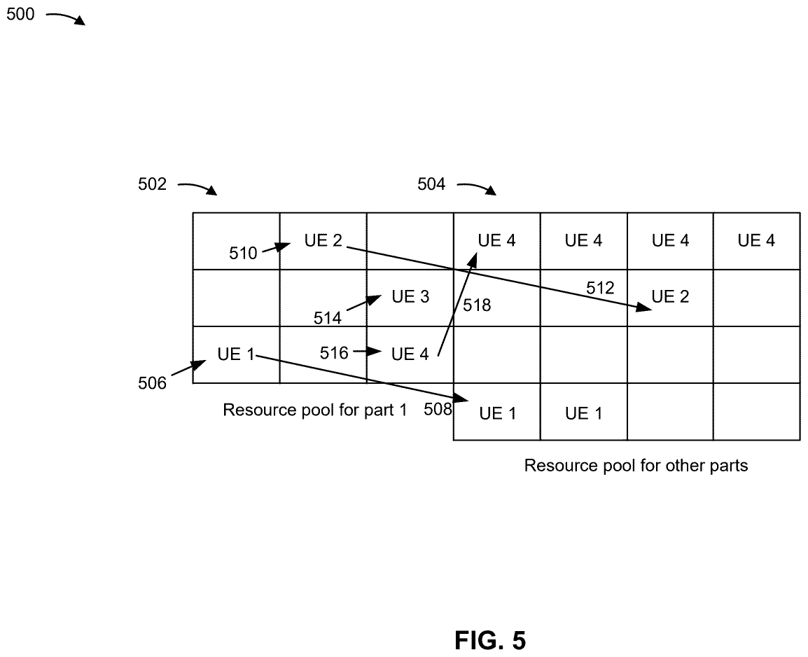

FIG. 5 is a diagram illustrating an example 500 associated with multipart packet transmission for contention-based uplink communications associated with multiple UEs. As shown in the example 500 of FIG. 5, resources for contention-based multipart uplink packet transmission include a first resource pool 502 associated with part 1 transmission and a second resource pool 504 associated with transmission of other parts. The resources for contention-based multipart uplink packet transmission (e.g., the first resource pool 502 and the second resource pool 504) are configured for multiple UEs (e.g., UE 120), including a first UE (UE1), a second UE (UE2), a third UE (UE3), and a fourth UE (UE4). In some aspects, a network node (e.g., network node 110) may perform blind decoding in the first resource pool 502, and the network node may refrain from performing blind decoding in the second resource pool 504.

As shown by reference number 506, UE1 may transmit a first part of a first uplink packet associated with UE1 in a resource included in the first resource pool 502. The network node may receive the first part of the first uplink packet associated with UE1 based on performing blind decoding in the first resource pool 502. The first part of the first uplink packet associated with UE1 may include control information and a first portion of data of the first uplink packet. As shown by reference number 508, the control information in the first part of the first uplink packet associated with UE1 may indicate selected resources, in the second resource pool 504, for transmission of a second part and a third part of the first uplink packet associated with UE1. UE1 may transmit the second part and the third part of the first uplink packet associated with UE1, and the network node may receive and decode the second part and the third part of the first uplink packet associated with UE1 based on the control information included in the first part of the first uplink packet associated with UE1.

As shown by reference number 510, UE2 may transmit a first part of a second uplink packet associated with UE2 in a resource included in the first resource pool 502. The network node may receive the first part of the second uplink packet associated with UE2 based on performing blind decoding in the first resource pool 502. The first part of the second uplink packet associated with UE2 may include control information and a first portion of data of the second uplink packet. As shown by reference number 512, the control information in the first part of the second uplink packet associated with UE2 may indicate a selected resource, in the second resource pool 504, for transmission of a second part of the second uplink packet associated with UE2. UE2 may transmit the second part of the second uplink packet associated with UE2, and the network node may receive and decode the second part of the second uplink packet associated with UE2 based on the control information included in the first part of the second uplink packet associated with UE2.

As shown by reference number 514, UE3 may transmit a first part of a third uplink packet associated with UE3 in a resource included in the first resource pool 502. The network node may receive the first part of the third uplink packet associated with UE3 based on performing blind decoding in the first resource pool 502. The first part of the third uplink packet associated with UE3 may include control information and a first portion of data of the third uplink packet. As shown in FIG. 5, UE3 transmits only the first part of the third uplink packet associated with UE3. That is, UE3 does not transmit any other part of the third uplink packet associated with UE3. In this case, the first portion of the data of the third uplink packet associated with UE3 includes all of the data of the third uplink packet. The control information included in the first part of the third uplink packet associated with UE3 may indicate, to the network node, that no other parts of the third uplink packet associated with U3 are to be transmitted.

As shown by reference number 516, UE 4 may transmit a first part of a fourth uplink packet associated with U4 in a resource included in the first resource pool 502. The network node may receive the first part of the fourth uplink packet associated with UE4 based on performing blind decoding in the first resource pool 502. The first part of the fourth uplink packet associated with UE4 may include control information and a first portion of data of the fourth uplink packet. As shown by reference number 518, the control information in the first part of the fourth uplink packet associated with UE4 may indicate selected resources, in the second resource pool 504, for transmission of a second part, a third part, a fourth part, and a fifth part of the fourth uplink packet associated with UE4. UE4 may transmit the second, third, fourth, and fifth parts of the fourth uplink packet associated with UE4 in the respective resources selected for the second, third, fourth, and fifth parts, and the network node may receive and decode the second, third, fourth, and fifth parts of the fourth uplink packet associated with UE4 based on the control information included in the first part of the fourth uplink packet associated with UE4.

As indicated above, FIG. 5 is provided as an example. Other examples may differ from what is described with respect to FIG. 5.

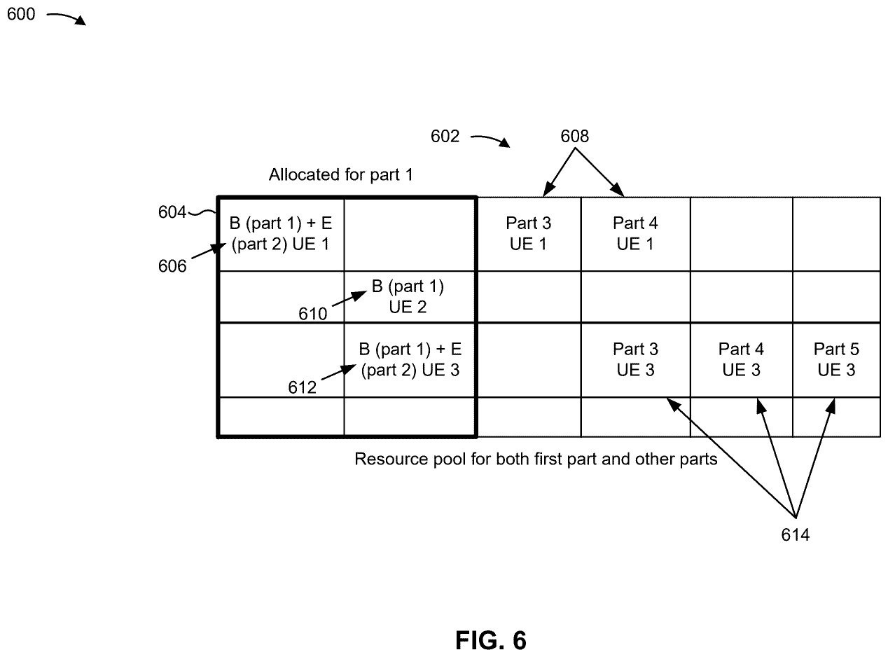

FIG. 6 is a diagram illustrating an example 600 associated with multipart packet transmission for contention-based uplink communications using transmissions in different layers in the power domain. As shown in the example 600 of FIG. 6, resources for contention-based multipart uplink packet transmission include a resource pool 602 that allocates resources associated with part 1 transmission and resources associated with transmission of other parts. The resource pool 602 includes a subset of resources 604 allocated for part 1 transmission. All of the resources in the resource pool 602 (e.g., the subset of resource 604 and the remaining resources, other than the subset of resources 604, in the resource pool 602) may be used for transmission of other parts of an uplink packet. The resources for contention-based multipart uplink packet transmission are configured for multiple UEs (e.g., UE 120), including a first UE (UE1), a second UE (UE2), and a third UE (UE3). In some aspects, a network node (e.g., network node 110) may perform blind decoding on the base layer (e.g., in the power domain) in the subset of resources 604, and the network node may refrain from performing blind decoding in the remaining resources, other than the subset of resources 604, in the resource pool 602.

As shown by reference number 606, UE 1 may transmit a first part of a first uplink packet associated with UE1 in the base layer in a first resource included in the subset of resources 604 allocated for part 1 transmission, and UE1 may transmit a second part of the first uplink packet associated with UE1 in the enhancement layer in the first resource. The network node may receive the first part of the first uplink packet associated with UE1 based on performing blind decoding on the base layer in the subset of resources 604. The first part of the first uplink packet associated with UE1 may include control information and a first portion of data of the first uplink packet. The control information in the first part of the first uplink packet associated with UE1 may indicate that at least one other part of the first uplink packet is transmitted in the enhancement layer in the first resource, and the network node may decode the second part of the first uplink packet associated with UE1 on the enhancement layer based on the control information included in the first part of the first uplink packet. As shown by reference number 608, UE1 may select (e.g., randomly select) resources in the resource pool 602 for transmission of a third part and a fourth part of the first packet associated with UE1. The control information included in the first part of the first uplink packet associated with UE1 may indicate the selected resources for the third part and the fourth part of the first uplink packet associated with UE1. UE1 may transmit the third part and the fourth part of the first uplink packet associated with UE1 in the selected resources, and the network node may receive and decode the third part and the fourth part of the first uplink packet associated with UE1 based on the control information included in the first part of the first uplink packet associated with UE1.

As shown by reference number 610, UE2 may transmit a first part of a second uplink packet associated with UE2 in the base layer in a second resource included in the subset of resources 604. The network node may receive the first part of the second uplink packet associated with UE2 based on performing blind decoding on the base layer in the subset of resources 604. The first part of the second uplink packet associated with UE2 may include control information and a first portion of data of the second uplink packet. As shown in FIG. 6, UE2 transmits only the first part of the second uplink packet associated with UE2. That is, UE2 does not transmit any other part of the second uplink packet associated with UE2. In this case, the first portion of the data of the second uplink packet associated with UE2 includes all of the data of the second uplink packet. The control information included in the first part of the second uplink packet associated with UE2 may indicate, to the network node, that no other parts of the second uplink packet associated with U2 are to be transmitted.

As shown by reference number 612, UE3 may transmit a first part of a third uplink packet associated with UE3 in the base layer in a third resource included in the subset of resources 604 allocated for part 1 transmission, and UE1 may transmit a second part of the third uplink packet associated with UE3 in the enhancement layer in the third resource. The network node may receive the first part of the third uplink packet associated with UE3 based on performing blind decoding on the base layer in the subset of resources 604. The first part of the third uplink packet associated with UE3 may include control information and a first portion of data of the third uplink packet. The control information in the first part of the third uplink packet associated with UE3 may indicate that at least one other part of the third uplink packet is transmitted in the enhancement layer in the third resource, and the network node may decode the second part of the third uplink packet associated with UE3 on the enhancement layer based on the control information included in the first part of the third uplink packet. As shown by reference number 614, UE3 may select (e.g., randomly select) resources in the resource pool 602 for transmission of third, fourth, and fifth parts of the third packet associated with UE3. The control information included in the first part of the third uplink packet associated with UE3 may indicate the selected resources for the third, fourth, and fifth parts of the third uplink packet associated with UE3. UE3 may transmit the third, fourth, and fifth parts of the third uplink packet associated with UE3 in the selected resources, and the network node may receive and decode the third, fourth, and fifth parts of the third uplink packet associated with UE3 based on the control information included in the first part of the third uplink packet associated with UE3.

As indicated above, FIG. 6 is provided as an example. Other examples may differ from what is described with respect to FIG. 6.

FIG. 7 is a diagram illustrating an example process 700 performed, for example, at a UE or an apparatus of a UE. Example process 700 is an example where the apparatus or the UE (e.g., UE 120) performs operations associated with multipart packet transmission for contention-based uplink communications.

As shown in FIG. 7, in some aspects, process 700 may include receiving configuration information indicating resources for multipart uplink packet transmission (block 710). For example, the UE (e.g., using reception component 902 or communication manager 906, depicted in FIG. 9) may receive configuration information indicating resources for multipart uplink packet transmission, as described above.

As further shown in FIG. 7, in some aspects, process 700 may include transmitting a first part of an uplink packet in accordance with the configuration information, wherein the first part includes control information and a first portion of data of the uplink packet (block 720). For example, the UE (e.g., using transmission component 904 or communication manager 906, depicted in FIG. 9) may transmit a first part of an uplink packet in accordance with the configuration information, wherein the first part includes control information and a first portion of data of the uplink packet, as described above.

As further shown in FIG. 7, in some aspects, process 700 may include selectively transmitting a second part of the uplink packet in accordance with the configuration information, wherein the second part includes a second portion of the data of the uplink packet (block 730). For example, the UE (e.g., using transmission component 904 or communication manager 906, depicted in FIG. 9) may selectively transmit a second part of the uplink packet in accordance with the configuration information, wherein the second part includes a second portion of the data of the uplink packet, as described above.

Process 700 may include additional aspects, such as any single aspect or any combination of aspects described below or in connection with one or more other processes described elsewhere herein.

In a first aspect, selectively transmitting the second part of the uplink packet includes transmitting the second part of the uplink packet in connection with a size of the uplink packet satisfying a threshold, or refraining from transmitting the second part of the uplink packet in connection with the size of the uplink packet failing to satisfy the threshold.

In a second aspect, alone or in combination with the first aspect, the resources for multipart uplink packet transmission are associated with multiple UEs that include the UE.

In a third aspect, alone or in combination with one or more of the first and second aspects, the resources for multipart uplink packet transmission include a first set of resources associated with contention-based transmission of the first part of the uplink packet and a second set of resources associated with contention-based transmission of one or more parts of the uplink packet other than the first part of the uplink packet.

In a fourth aspect, alone or in combination with one or more of the first through third aspects, transmitting the first part of the uplink packet includes transmitting the first part of the uplink packet via a first resource included in the first set of resources.

In a fifth aspect, alone or in combination with one or more of the first through fourth aspects, selectively transmitting the second part of the uplink packet includes transmitting the second part of the uplink packet via a second resource included in the second set of resources.

In a sixth aspect, alone or in combination with one or more of the first through fifth aspects, process 700 includes transmitting one or more additional parts of the uplink packet, in addition to the first part and the second part, via respective resources included in the second set of resources.

In a seventh aspect, alone or in combination with one or more of the first through sixth aspects, the configuration information indicates a first resource pool that includes the first set of resources and a second resource pool that includes the second set of resources.

In an eighth aspect, alone or in combination with one or more of the first through seventh aspects, the first resource pool and the second resource pool are separated by a time gap.

In a ninth aspect, alone or in combination with one or more of the first through eighth aspects, a first collision probability associated with the first resource pool is less than a second collision probability associated with the second resource pool.

In a tenth aspect, alone or in combination with one or more of the first through ninth aspects, the first resource pool is based at least in part on a blind decoding complexity supported by a network node.

In an eleventh aspect, alone or in combination with one or more of the first through tenth aspects, the configuration information indicates a resource pool including the resources for multipart uplink packet transmission, the first set of resources includes a subset of resources included in the resource pool, and the second set of resources includes the subset of resources and remaining resources, other than the subset of resources, included in the resource pool.

In a twelfth aspect, alone or in combination with one or more of the first through eleventh aspects, the subset of resources is allocated in one or more initial symbols of the resource pool.

In a thirteenth aspect, alone or in combination with one or more of the first through twelfth aspects, transmitting the first part of the uplink packet includes transmitting the first part of the uplink packet in a first resource in the first set of resources, selectively transmitting the second part of the uplink packet includes transmitting the second part of the uplink packet in a second resource in the second set of resources, and the second resource is at a same symbol as the first resource or a later symbol than the first resource.

In a fourteenth aspect, alone or in combination with one or more of the first through thirteenth aspects, transmitting the first part of the uplink packet includes transmitting the first part of the uplink packet via a base layer in a first resource included in the first set of resources, and selectively transmitting the second part of the uplink packet includes transmitting the second part of the uplink packet via an enhancement layer in the first resource.

In a fifteenth aspect, alone or in combination with one or more of the first through fourteenth aspects, process 700 includes transmitting one or more additional parts of the uplink packet, in addition to the first part and the second part, via respective resources included in the second set of resources.

In a sixteenth aspect, alone or in combination with one or more of the first through fifteenth aspects, the control information indicates that the second part of the uplink packet is to be transmitted, and the control information further indicates at least one of a resource, from the resources for multipart uplink packet transmission, for transmission of the second part, a modulation and coding scheme associated with transmission of the second part, a number of layers associated with transmission of the second part, or a payload size associated with transmission of the second part.

In a seventeenth aspect, alone or in combination with one or more of the first through sixteenth aspects, the control information indicates the resource for transmission of the second part using a resource identifier associated with a resource pool indicated in the configuration information.

In an eighteenth aspect, alone or in combination with one or more of the first through seventeenth aspects, the control information indicates whether the second part is transmitted via an enhancement layer in a same resource as the first part.

In a nineteenth aspect, alone or in combination with one or more of the first through eighteenth aspects, selectively transmitting the second part of the uplink packet includes transmitting the second part of the uplink packet in accordance with the control information.

In a twentieth aspect, alone or in combination with one or more of the first through nineteenth aspects, the control information indicates that no part of the uplink packet, other than the first part, is to be transmitted.

In a twenty-first aspect, alone or in combination with one or more of the first through twentieth aspects, selectively transmitting the second part of the uplink packet includes refraining from transmitting the second part of the uplink packet.

In a twenty-second aspect, alone or in combination with one or more of the first through twenty-first aspects, the control information includes a UE identifier associated with the UE.

In a twenty-third aspect, alone or in combination with one or more of the first through twenty-second aspects, the first part of the uplink packet includes UCI, separate from the first portion of the data, that includes the control information, and the UCI is associated with a cyclic redundancy check (CRC) specific to the UCI,.

In a twenty-fourth aspect, alone or in combination with one or more of the first through twenty-third aspects, the control information is embedded with the first portion of the data in a payload of the first part of the uplink packet.

In a twenty-fifth aspect, alone or in combination with one or more of the first through twenty-fourth aspects, process 700 includes receiving a UE-specific ACK indicative of successful decoding of all parts of the uplink packet.

In a twenty-sixth aspect, alone or in combination with one or more of the first through twenty-fifth aspects, the UE-specific ACK is received via DCI scrambled by a user ID associated with the UE, GC-DCI with a payload including a UE ID associated with the UE, or GC-DCI including an ACK/NACK bit mapped to a resource ID associated with a resource pool.

In a twenty-seventh aspect, alone or in combination with one or more of the first through twenty-sixth aspects, selectively transmitting the second part of the uplink packet includes transmitting the second part of the uplink packet, and process 700 includes receiving feedback indicative of successful decoding of the first part and unsuccessful decoding of the second part, and retransmitting the second part based at least in part on the feedback.

In a twenty-eighth aspect, alone or in combination with one or more of the first through twenty-seventh aspects, the feedback includes a NACK, received via DCI or GC-DCI, that indicates information associated with the second part, a retransmission grant received via DCI scrambled by a user ID associated with the UE, or a NACK, indicated in GC-DCI, via an ACK/NACK bit mapped to a resource ID associated with a resource pool.

In a twenty-ninth aspect, alone or in combination with one or more of the first through twenty-eighth aspects, process 700 includes receiving feedback indicative of successful decoding of the control information and unsuccessful decoding of at least one of the first portion of the data or the second part, and retransmitting the at least one of the first portion of the data or the second part based at least in part on the feedback.

In a thirtieth aspect, alone or in combination with one or more of the first through twenty-ninth aspects, the feedback includes a NACK, received via DCI or GC-DCI, that indicates information associated with the at least one of the first portion of the data or the second part, a retransmission grant received via DCI scrambled by a user ID associated with the UE, or a NACK, indicated in GC-DCI, via an ACK/NACK bit mapped to a resource ID associated with a resource pool.

In a thirty-first aspect, alone or in combination with one or more of the first through thirtieth aspects, process 700 includes retransmitting the first part of the uplink packet, and selectively retransmitting the second part of the uplink packet, in connection with a determination that no ACK/NACK feedback associated with the uplink packet has been received.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node. Example process 800 is an example where the apparatus or the network node (e.g., network node 110) performs operations associated with multipart packet transmission for contention-based uplink communications.

As shown in FIG. 8, in some aspects, process 800 may include transmitting configuration information indicating resources for multipart uplink packet transmission (block 810). For example, the network node (e.g., using transmission component 1004 or communication manager 1006, depicted in FIG. 10) may transmit configuration information indicating resources for multipart uplink packet transmission, as described above.

As further shown in FIG. 8, in some aspects, process 800 may include receiving, based on blind decoding in a first set of resources of the resources for multipart uplink packet transmission, a first part of an uplink packet associated with a UE, wherein the first part includes control information and a first portion of data of the uplink packet (block 820). For example, the network node (e.g., using reception component 1002 or communication manager 1006, depicted in FIG. 10) may receive, based on blind decoding in a first set of resources of the resources for multipart uplink packet transmission, a first part of an uplink packet associated with a UE, wherein the first part includes control information and a first portion of data of the uplink packet, as described above.

As further shown in FIG. 8, in some aspects, process 800 may include selectively receiving, based on the control information, a second part of the uplink packet associated with the UE, wherein the second part includes a second portion of the data of the uplink packet (block 830). For example, the network node (e.g., using reception component 1002 or communication manager 1006, depicted in FIG. 10) may selectively receive, based on the control information, a second part of the uplink packet associated with the UE, wherein the second part includes a second portion of the data of the uplink packet, as described above.

Process 800 may include additional aspects, such as any single aspect or any combination of aspects described below or in connection with one or more other processes described elsewhere herein.

In a first aspect, transmitting the configuration information includes transmitting the configuration information indicating the resources for multipart uplink packet transmission to multiple UEs that include the UE.

In a second aspect, alone or in combination with the first aspect, the resources for multipart uplink packet transmission include a first set of resources associated with contention-based transmission of the first part of the uplink packet and a second set of resources associated with contention-based transmission of one or more parts of the uplink packet other than the first part of the uplink packet.

In a third aspect, alone or in combination with one or more of the first and second aspects, receiving the first part of the uplink packet includes receiving the first part of the uplink packet via a first resource included in the first set of resources.

In a fourth aspect, alone or in combination with one or more of the first through third aspects, selectively receiving the second part of the uplink packet includes receiving the second part of the uplink packet via a second resource included in the second set of resources.

In a fifth aspect, alone or in combination with one or more of the first through fourth aspects, process 800 includes receiving one or more additional parts of the uplink packet, in addition to the first part and the second part, via respective resources included in the second set of resources.

In a sixth aspect, alone or in combination with one or more of the first through fifth aspects, the configuration information indicates a first resource pool that includes the first set of resources and a second resource pool that includes the second set of resources.

In a seventh aspect, alone or in combination with one or more of the first through sixth aspects, the first resource pool and the second resource pool are separated by a time gap.

In an eighth aspect, alone or in combination with one or more of the first through seventh aspects, a first collision probability associated with the first resource pool is less than a second collision probability associated with the second resource pool.

In a ninth aspect, alone or in combination with one or more of the first through eighth aspects, the first resource pool is based at least in part on a blind decoding complexity supported by the network node.

In a tenth aspect, alone or in combination with one or more of the first through ninth aspects, the configuration information indicates a resource pool including the resources for multipart uplink packet transmission, the first set of resources includes a subset of resources included in the resource pool, and the second set of resources includes the subset of resources and remaining resources, other than the subset of resources, included in the resource pool.

In an eleventh aspect, alone or in combination with one or more of the first through tenth aspects, the subset of resources is allocated in one or more initial symbols of the resource pool.

In a twelfth aspect, alone or in combination with one or more of the first through eleventh aspects, receiving the first part of the uplink packet includes receiving the first part of the uplink packet in a first resource in the first set of resources, selectively receiving the second part of the uplink packet includes receiving the second part of the uplink packet in a second resource in the second set of resources, and the second resource is at a same symbol as the first resource or a later symbol than the first resource.

In a thirteenth aspect, alone or in combination with one or more of the first through twelfth aspects, receiving the first part of the uplink packet includes receiving the first part of the uplink packet via a base layer in a first resource included in the first set of resources, and selectively receiving the second part of the uplink packet includes receiving the second part of the uplink packet via an enhancement layer in the first resource.

In a fourteenth aspect, alone or in combination with one or more of the first through thirteenth aspects, process 800 includes receiving one or more additional parts of the uplink packet, in addition to the first part and the second part, via respective resources included in the second set of resources.

In a fifteenth aspect, alone or in combination with one or more of the first through fourteenth aspects, the control information indicates that the second part of the uplink packet is to be transmitted by the UE, and the control information further indicates at least one of a resource, from the resources for multipart uplink packet transmission, for transmission of the second part, a modulation and coding scheme associated with transmission of the second part, a number of layers associated with transmission of the second part, or a payload size associated with transmission of the second part.

In a sixteenth aspect, alone or in combination with one or more of the first through fifteenth aspects, the control information indicates the resource for transmission of the second part using a resource identifier associated with a resource pool indicated in the configuration information.

In a seventeenth aspect, alone or in combination with one or more of the first through sixteenth aspects, the control information indicates whether the second part is transmitted via an enhancement layer in a same resource as the first part.

In an eighteenth aspect, alone or in combination with one or more of the first through seventeenth aspects, selectively receiving the second part of the uplink packet includes receiving the second part of the uplink packet in accordance with the control information.

In a nineteenth aspect, alone or in combination with one or more of the first through eighteenth aspects, the control information indicates that no part of the uplink packet, other than the first part, is to be transmitted.

In a twentieth aspect, alone or in combination with one or more of the first through nineteenth aspects, selectively receiving the second part of the uplink packet includes refraining from receiving the second part of the uplink packet.

In a twenty-first aspect, alone or in combination with one or more of the first through twentieth aspects, the control information includes a UE identifier associated with the UE.

In a twenty-second aspect, alone or in combination with one or more of the first through twenty-first aspects, the first part of the uplink packet includes UCI, separate from the first portion of the data, that includes the control information, and the UCI is associated with a cyclic redundancy check (CRC) specific to the UCI.

In a twenty-third aspect, alone or in combination with one or more of the first through twenty-second aspects, the control information is embedded with the first portion of the data in a payload of the first part of the uplink packet.

In a twenty-fourth aspect, alone or in combination with one or more of the first through twenty-third aspects, process 800 includes transmitting a UE-specific ACK indicative of successful decoding of all parts of the uplink packet.

In a twenty-fifth aspect, alone or in combination with one or more of the first through twenty-fourth aspects, the UE-specific ACK is transmitted via DCI scrambled by a user ID associated with the UE, GC-DCI with a payload including a UE ID associated with the UE, or GC-DCI including an ACK/NACK bit mapped to a resource ID associated with a resource pool.

In a twenty-sixth aspect, alone or in combination with one or more of the first through twenty-fifth aspects, selectively receiving the second part of the uplink packet includes receiving the second part of the uplink packet, and process 800 includes transmitting feedback indicative of successful decoding of the first part and unsuccessful decoding of the second part.

In a twenty-seventh aspect, alone or in combination with one or more of the first through twenty-sixth aspects, the feedback includes a NACK, transmitted via DCI or GC-DCI, that indicates information associated with the second part, a retransmission grant transmitted via DCI scrambled by a user ID associated with the UE, or a NACK, indicated in GC-DCI, via an ACK/NACK bit mapped to a resource ID associated with a resource pool.

In a twenty-eighth aspect, alone or in combination with one or more of the first through twenty-seventh aspects, process 800 includes transmitting feedback indicative of successful decoding of the control information and unsuccessful decoding of at least one of the first portion of the data or the second part.

In a twenty-ninth aspect, alone or in combination with one or more of the first through twenty-eighth aspects, the feedback includes a NACK, transmitted via DCI or GC-DCI, that indicates information associated with the at least one of the first portion of the data or the second part, a retransmission grant transmitted via DCI scrambled by a user ID associated with the UE, or a NACK, indicated in GC-DCI, via an ACK/NACK bit mapped to a resource ID associated with a resource pool.

In a thirtieth aspect, alone or in combination with one or more of the first through twenty-ninth aspects, process 800 includes refraining from transmitting ACK/NACK feedback associated with the uplink packet in connection with unsuccessful decoding of the control information included in the first part.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a UE, or a UE may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3, 4A-4C, and 5-6. Additionally, or alternatively, the apparatus 900 may be configured to perform one or more processes described herein, such as process 700 of FIG. 7, or a combination thereof. In some aspects, the apparatus 900 or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The reception component 902 may receive configuration information indicating resources for multipart uplink packet transmission. The transmission component 904 may transmit a first part of an uplink packet in accordance with the configuration information, wherein the first part includes control information and a first portion of data of the uplink packet. The transmission component 904 may selectively transmit a second part of the uplink packet in accordance with the configuration information, wherein the second part includes a second portion of the data of the uplink packet.

The transmission component 904 may transmit one or more additional parts of the uplink packet, in addition to the first part and the second part, via respective resources included in the second set of resources.

The transmission component 904 may transmit one or more additional parts of the uplink packet, in addition to the first part and the second part, via respective resources included in the second set of resources.

The reception component 902 may receive a UE-specific ACK indicative of successful decoding of all parts of the uplink packet.

The reception component 902 may receive feedback indicative of successful decoding of the first part and unsuccessful decoding of the second part.

The transmission component 904 may retransmit the second part based at least in part on the feedback.

The reception component 902 may receive feedback indicative of successful decoding of the control information and unsuccessful decoding of at least one of the first portion of the data or the second part.

The transmission component 904 may retransmit the at least one of the first portion of the data or the second part based at least in part on the feedback.

The transmission component 904 may retransmit the first part of the uplink packet, and selectively retransmit the second part of the uplink packet, in connection with a determination that no ACK/NACK feedback associated with the uplink packet has been received.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3, 4A-4C, and 5-6. Additionally, or alternatively, the apparatus 1000 may be configured to perform one or more processes described herein, such as process 800 of FIG. 8, or a combination thereof. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit configuration information indicating resources for multipart uplink packet transmission. The reception component 1002 may receive, based on blind decoding in a first set of resources of the resources for multipart uplink packet transmission, a first part of an uplink packet associated with a UE, wherein the first part includes control information and a first portion of data of the uplink packet. The reception component 1002 may selectively receive, based on the control information, a second part of the uplink packet associated with the UE, wherein the second part includes a second portion of the data of the uplink packet.

The reception component 1002 may receive one or more additional parts of the uplink packet, in addition to the first part and the second part, via respective resources included in the second set of resources.

The reception component 1002 may receive one or more additional parts of the uplink packet, in addition to the first part and the second part, via respective resources included in the second set of resources.

The transmission component 1004 may transmit a UE-specific ACK indicative of successful decoding of all parts of the uplink packet.

The transmission component 1004 may transmit feedback indicative of successful decoding of the first part and unsuccessful decoding of the second part.

The transmission component 1004 may transmit feedback indicative of successful decoding of the control information and unsuccessful decoding of at least one of the first portion of the data or the second part.

The communication manager 1006 may refrain from transmitting ACK/NACK feedback associated with the uplink packet in connection with unsuccessful decoding of the control information included in the first part.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving configuration information indicating resources for multipart uplink packet transmission; transmitting a first part of an uplink packet in accordance with the configuration information, wherein the first part includes control information and a first portion of data of the uplink packet; and selectively transmitting a second part of the uplink packet in accordance with the configuration information, wherein the second part includes a second portion of the data of the uplink packet.

Aspect 2: The method of Aspect 1, wherein selectively transmitting the second part of the uplink packet comprises: transmitting the second part of the uplink packet in connection with a size of the uplink packet satisfying a threshold; or refraining from transmitting the second part of the uplink packet in connection with the size of the uplink packet failing to satisfy the threshold.

Aspect 3: The method of any of Aspects 1-2, wherein the resources for multipart uplink packet transmission are associated with multiple UEs that include the UE.

Aspect 4: The method of any of Aspects 1-3, wherein the resources for multipart uplink packet transmission include a first set of resources associated with contention-based transmission of the first part of the uplink packet and a second set of resources associated with contention-based transmission of one or more parts of the uplink packet other than the first part of the uplink packet.

Aspect 5: The method of Aspect 4, wherein transmitting the first part of the uplink packet comprises: transmitting the first part of the uplink packet via a first resource included in the first set of resources.

Aspect 6: The method of Aspect 5, wherein selectively transmitting the second part of the uplink packet comprises: transmitting the second part of the uplink packet via a second resource included in the second set of resources.

Aspect 7: The method of Aspect 6, further comprising: transmitting one or more additional parts of the uplink packet, in addition to the first part and the second part, via respective resources included in the second set of resources.

Aspect 8: The method of any of Aspects 4-6, wherein the configuration information indicates a first resource pool that includes the first set of resources and a second resource pool that includes the second set of resources.

Aspect 9: The method of Aspect 8, wherein the first resource pool and the second resource pool are separated by a time gap.

Aspect 10: The method of any of Aspects 8-9, wherein a first collision probability associated with the first resource pool is less than a second collision probability associated with the second resource pool.

Aspect 11: The method of any of Aspects 8-10, wherein the first resource pool is based at least in part on a blind decoding complexity supported by a network node.

Aspect 12: The method of any of Aspects 4-6, wherein the configuration information indicates a resource pool including the resources for multipart uplink packet transmission, wherein the first set of resources includes a subset of resources included in the resource pool, and wherein the second set of resources includes the subset of resources and remaining resources, other than the subset of resources, included in the resource pool.

Aspect 13: The method of Aspect 12, wherein the subset of resources is allocated in one or more initial symbols of the resource pool.

Aspect 14: The method of any of Aspects 12-13, wherein transmitting the first part of the uplink packet comprises transmitting the first part of the uplink packet in a first resource in the first set of resources, wherein selectively transmitting the second part of the uplink packet comprises transmitting the second part of the uplink packet in a second resource in the second set of resources, and wherein the second resource is at a same symbol as the first resource or a later symbol than the first resource.

Aspect 15: The method of any of Aspects 4-14, wherein transmitting the first part of the uplink packet comprises transmitting the first part of the uplink packet via a base layer in a first resource included in the first set of resources, and wherein selectively transmitting the second part of the uplink packet comprises transmitting the second part of the uplink packet via an enhancement layer in the first resource.

Aspect 16: The method of Aspect 15, further comprising: transmitting one or more additional parts of the uplink packet, in addition to the first part and the second part, via respective resources included in the second set of resources.

Aspect 17: The method of any of Aspects 1-16, wherein the control information indicates that the second part of the uplink packet is to be transmitted, and wherein the control information further indicates at least one of: a resource, from the resources for multipart uplink packet transmission, for transmission of the second part, a modulation and coding scheme associated with transmission of the second part, a number of layers associated with transmission of the second part, or a payload size associated with transmission of the second part.

Aspect 18: The method of Aspect 17, wherein the control information indicates the resource for transmission of the second part using a resource identifier associated with a resource pool indicated in the configuration information.

Aspect 19: The method of any of Aspects 17-18, wherein the control information indicates whether the second part is transmitted via an enhancement layer in a same resource as the first part.

Aspect 20: The method of any of Aspects 17-19, wherein selectively transmitting the second part of the uplink packet comprises: transmitting the second part of the uplink packet in accordance with the control information.

Aspect 21: The method of any of Aspects 1-16, wherein the control information indicates that no part of the uplink packet, other than the first part, is to be transmitted.

Aspect 22: The method of Aspect 21, wherein selectively transmitting the second part of the uplink packet comprises: refraining from transmitting the second part of the uplink packet.

Aspect 23: The method of any of Aspects 1-22, wherein the control information includes a UE identifier associated with the UE.

Aspect 24: The method of any of Aspects 1-23, wherein the first part of the uplink packet includes uplink control information (UCI), separate from the first portion of the data, that includes the control information, and wherein the UCI is associated with a cyclic redundancy check (CRC) specific to the UCI.

Aspect 25: The method of any of Aspects 1-23, wherein the control information is embedded with the first portion of the data in a payload of the first part of the uplink packet.

Aspect 26: The method of any of Aspects 1-25, further comprising: receiving a UE-specific acknowledgement (ACK) indicative of successful decoding of all parts of the uplink packet.

Aspect 27: The method of Aspect 26, wherein the UE-specific ACK is received via: downlink control information (DCI) scrambled by a user identifier (ID) associated with the UE, group common DCI (GC-DCI) with a payload including a UE ID associated with the UE, or GC-DCI including an ACK or negative acknowledgment (NACK) (ACK/NACK) bit mapped to a resource ID associated with a resource pool.

Aspect 28: The method of any of Aspects 1-27, wherein selectively transmitting the second part of the uplink packet comprises transmitting the second part of the uplink packet, and wherein the method further comprises: receiving feedback indicative of successful decoding of the first part and unsuccessful decoding of the second part; and retransmitting the second part based at least in part on the feedback.

Aspect 29: The method of Aspect 28, wherein the feedback includes: a negative acknowledgement (NACK), received via downlink control information (DCI) or group common DCI (GC-DCI), that indicates information associated with the second part, a retransmission grant received via DCI scrambled by a user identifier (ID) associated with the UE, or a NACK, indicated in GC-DCI, via an acknowledgment (ACK) or NACK (ACK/NACK) bit mapped to a resource ID associated with a resource pool.

Aspect 30: The method of any of Aspects 1-29, further comprising: receiving feedback indicative of successful decoding of the control information and unsuccessful decoding of at least one of the first portion of the data or the second part; and retransmitting the at least one of the first portion of the data or the second part based at least in part on the feedback.

Aspect 31: The method of Aspect 30, wherein the feedback includes: a negative acknowledgement (NACK), received via downlink control information (DCI) or group common DCI (GC-DCI), that indicates information associated with the at least one of the first portion of the data or the second part, a retransmission grant received via DCI scrambled by a user identifier (ID) associated with the UE, or a NACK, indicated in GC-DCI, via an acknowledgment (ACK) or NACK (ACK/NACK) bit mapped to a resource ID associated with a resource pool.

Aspect 32: The method of any of Aspects 1-31, further comprising: retransmitting the first part of the uplink packet, and selectively retransmitting the second part of the uplink packet, in connection with a determination that no acknowledgment (ACK) or negative acknowledgment (NACK) (ACK/NACK) feedback associated with the uplink packet has been received.

Aspect 33: A method of wireless communication performed by a network node, comprising: transmitting configuration information indicating resources for multipart uplink packet transmission; receiving, based on blind decoding in a first set of resources of the resources for multipart uplink packet transmission, a first part of an uplink packet associated with a UE, wherein the first part includes control information and a first portion of data of the uplink packet; and selectively receiving, based on the control information, a second part of the uplink packet associated with the UE, wherein the second part includes a second portion of the data of the uplink packet.

Aspect 34: The method of Aspect 33, wherein transmitting the configuration information comprises: transmitting the configuration information indicating the resources for multipart uplink packet transmission to multiple UEs that include the UE.

Aspect 35: The method of any of Aspects 33-34, wherein the resources for multipart uplink packet transmission include a first set of resources associated with contention-based transmission of the first part of the uplink packet and a second set of resources associated with contention-based transmission of one or more parts of the uplink packet other than the first part of the uplink packet.

Aspect 36: The method of Aspect 35, wherein receiving the first part of the uplink packet comprises: receiving the first part of the uplink packet via a first resource included in the first set of resources.

Aspect 37: The method of Aspect 36, wherein selectively receiving the second part of the uplink packet comprises: receiving the second part of the uplink packet via a second resource included in the second set of resources.

Aspect 38: The method of Aspect 37, further comprising: receiving one or more additional parts of the uplink packet, in addition to the first part and the second part, via respective resources included in the second set of resources.

Aspect 39: The method of any of Aspects 35-38, wherein the configuration information indicates a first resource pool that includes the first set of resources and a second resource pool that includes the second set of resources.

Aspect 40: The method of Aspect 39, wherein the first resource pool and the second resource pool are separated by a time gap.

Aspect 41: The method of any of Aspects 39-40, wherein a first collision probability associated with the first resource pool is less than a second collision probability associated with the second resource pool.

Aspect 42: The method of any of Aspects 39-41, wherein the first resource pool is based at least in part on a blind decoding complexity supported by the network node.

Aspect 43: The method of any of Aspects 35-38, wherein the configuration information indicates a resource pool including the resources for multipart uplink packet transmission, wherein the first set of resources includes a subset of resources included in the resource pool, and wherein the second set of resources includes the subset of resources and remaining resources, other than the subset of resources, included in the resource pool.

Aspect 44: The method of Aspect 43, wherein the subset of resources is allocated in one or more initial symbols of the resource pool.

Aspect 45: The method of any of Aspects 43-44, wherein receiving the first part of the uplink packet comprises receiving the first part of the uplink packet in a first resource in the first set of resources, wherein selectively receiving the second part of the uplink packet comprises receiving the second part of the uplink packet in a second resource in the second set of resources, and wherein the second resource is at a same symbol as the first resource or a later symbol than the first resource.

Aspect 46: The method of any of Aspects 35-45, wherein receiving the first part of the uplink packet comprises receiving the first part of the uplink packet via a base layer in a first resource included in the first set of resources, and wherein selectively receiving the second part of the uplink packet comprises receiving the second part of the uplink packet via an enhancement layer in the first resource.

Aspect 47: The method of Aspect 46, further comprising: receiving one or more additional parts of the uplink packet, in addition to the first part and the second part, via respective resources included in the second set of resources.

Aspect 48: The method of any of Aspects 33-47, wherein the control information indicates that the second part of the uplink packet is to be transmitted by the UE, and wherein the control information further indicates at least one of: a resource, from the resources for multipart uplink packet transmission, for transmission of the second part, a modulation and coding scheme associated with transmission of the second part, a number of layers associated with transmission of the second part, or a payload size associated with transmission of the second part.

Aspect 49: The method of Aspect 48, wherein the control information indicates the resource for transmission of the second part using a resource identifier associated with a resource pool indicated in the configuration information.

Aspect 50: The method of any of Aspects 48-49, wherein the control information indicates whether the second part is transmitted via an enhancement layer in a same resource as the first part.

Aspect 51: The method of any of Aspects 48-50, wherein selectively receiving the second part of the uplink packet comprises: receiving the second part of the uplink packet in accordance with the control information.

Aspect 52: The method of any of Aspects 33-47, wherein the control information indicates that no part of the uplink packet, other than the first part, is to be transmitted.

Aspect 53: The method of Aspect 52, wherein selectively receiving the second part of the uplink packet comprises: refraining from receiving the second part of the uplink packet.

Aspect 54: The method of any of Aspects 33-53, wherein the control information includes a UE identifier associated with the UE.

Aspect 55: The method of any of Aspects 33-54, wherein the first part of the uplink packet includes uplink control information (UCI), separate from the first portion of the data, that includes the control information, and wherein the UCI is associated with a cyclic redundancy check (CRC) specific to the UCI.

Aspect 56: The method of any of Aspects 33-54, wherein the control information is embedded with the first portion of the data in a payload of the first part of the uplink packet.

Aspect 57: The method of any of Aspects 33-56, further comprising: transmitting a UE-specific acknowledgement (ACK) indicative of successful decoding of all parts of the uplink packet.

Aspect 58: The method of Aspect 57, wherein the UE-specific ACK is transmitted via: downlink control information (DCI) scrambled by a user identifier (ID) associated with the UE, group common DCI (GC-DCI) with a payload including a UE ID associated with the UE, or GC-DCI including an ACK or negative acknowledgment (NACK) (ACK/NACK) bit mapped to a resource ID associated with a resource pool.

Aspect 59: The method of any of Aspects 33-58, wherein selectively receiving the second part of the uplink packet comprises receiving the second part of the uplink packet, and wherein the method further comprises: transmitting feedback indicative of successful decoding of the first part and unsuccessful decoding of the second part.

Aspect 60: The method of Aspect 59, wherein the feedback includes: a negative acknowledgement (NACK), transmitted via downlink control information (DCI) or group common DCI (GC-DCI), that indicates information associated with the second part, a retransmission grant transmitted via DCI scrambled by a user identifier (ID) associated with the UE, or a NACK, indicated in GC-DCI, via an acknowledgment (ACK) or NACK (ACK/NACK) bit mapped to a resource ID associated with a resource pool.

Aspect 61: The method of any of Aspects 33-60, further comprising: transmitting feedback indicative of successful decoding of the control information and unsuccessful decoding of at least one of the first portion of the data or the second part.

Aspect 62: The method of Aspect 61, wherein the feedback includes: a negative acknowledgement (NACK), transmitted via downlink control information (DCI) or group common DCI (GC-DCI), that indicates information associated with the at least one of the first portion of the data or the second part, a retransmission grant transmitted via DCI scrambled by a user identifier (ID) associated with the UE, or a NACK, indicated in GC-DCI, via an acknowledgment (ACK) or NACK (ACK/NACK) bit mapped to a resource ID associated with a resource pool.

Aspect 63: The method of any of Aspects 33-62, further comprising: refraining from transmitting acknowledgment (ACK) or negative acknowledgment (NACK) (ACK/NACK) feedback associated with the uplink packet in connection with unsuccessful decoding of the control information included in the first part.

Aspect 64: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-63.

Aspect 65: An apparatus for wireless communication at a device, the apparatus comprising one or more memories and one or more processors coupled to the one or more memories, the one or more processors configured to cause the device to perform the method of one or more of Aspects 1-63.

Aspect 66: An apparatus for wireless communication, the apparatus comprising at least one means for performing the method of one or more of Aspects 1-63.

Aspect 67: A non-transitory computer-readable medium storing code for wireless communication, the code comprising instructions executable by one or more processors to perform the method of one or more of Aspects 1-63.

Aspect 68: A non-transitory computer-readable medium storing a set of instructions for wireless communication, the set of instructions comprising one or more instructions that, when executed by one or more processors of a device, cause the device to perform the method of one or more of Aspects 1-63.

Aspect 69: A device for wireless communication, the device comprising a processing system that includes one or more processors and one or more memories coupled with the one or more processors, the processing system configured to cause the device to perform the method of one or more of Aspects 1-63.

Aspect 70: An apparatus for wireless communication at a device, the apparatus comprising one or more memories and one or more processors coupled to the one or more memories, the one or more processors individually or collectively configured to cause the device to perform the method of one or more of Aspects 1-63.

Aspect 71: A device comprising a processing system that includes one or more processors and one or more code-storing memories coupled with the one or more processors, the processing system configured to cause the device to perform the method of one or more of Aspects 1-63.

Aspect 72: A device comprising a processing system that includes processor circuitry and code-storing memory circuitry, the processing system configured to cause the device to perform the method of one or more of Aspects 1-63.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive configuration information indicating resources for multipart uplink packet transmission;
transmit a first part of an uplink packet in accordance with the configuration information, wherein the first part includes control information and a first portion of data of the uplink packet; and
selectively transmit a second part of the uplink packet in accordance with the configuration information, wherein the second part includes a second portion of the data of the uplink packet.

2. The UE of claim 1, wherein to cause the UE to selectively transmit the second part of the uplink packet, the processing system is configured to cause the UE to:
transmit the second part of the uplink packet in connection with a size of the uplink packet satisfying a threshold; or
refrain from transmitting the second part of the uplink packet in connection with the size of the uplink packet failing to satisfy the threshold.

3. The UE of claim 1, wherein the resources for multipart uplink packet transmission include a first set of resources associated with contention-based transmission of the first part of the uplink packet and a second set of resources associated with contention-based transmission of one or more parts of the uplink packet other than the first part of the uplink packet.

4. The UE of claim 3, wherein to cause the UE to transmit the first part of the uplink packet, the processing system is configured to cause the UE to:
transmit the first part of the uplink packet via a first resource included in the first set of resources.

5. The UE of claim 4, wherein to cause the UE to selectively transmit the second part of the uplink packet, the processing system is configured to cause the UE to:
transmit the second part of the uplink packet via a second resource included in the second set of resources.

6. The UE of claim 5, wherein the processing system is configured to cause the UE to:
transmit one or more additional parts of the uplink packet, in addition to the first part and the second part, via respective resources included in the second set of resources.

7. The UE of claim 3, wherein the configuration information indicates a first resource pool that includes the first set of resources and a second resource pool that includes the second set of resources.

8. The UE of claim 3, wherein the configuration information indicates a resource pool including the resources for multipart uplink packet transmission,
wherein the first set of resources includes a subset of resources included in the resource pool, and
wherein the second set of resources includes the subset of resources and remaining resources, other than the subset of resources, included in the resource pool.

9. The UE of claim 3, wherein to cause the UE to transmit the first part of the uplink packet, the processing system is configured to cause the UE to transmit the first part of the uplink packet via a base layer in a first resource included in the first set of resources, and
wherein to cause the UE to selectively transmit the second part of the uplink packet, the processing system is configured to cause the UE to transmit the second part of the uplink packet via an enhancement layer in the first resource.

10. The UE of claim 1, wherein the control information indicates that the second part of the uplink packet is to be transmitted, and wherein the control information further indicates at least one of:
a resource, from the resources for multipart uplink packet transmission, for transmission of the second part,
a modulation and coding scheme associated with transmission of the second part,
a number of layers associated with transmission of the second part, or
a payload size associated with transmission of the second part.

11. The UE of claim 10, wherein the control information indicates whether the second part is transmitted via an enhancement layer in a same resource as the first part.

12. The UE of claim 1, wherein the control information indicates that no part of the uplink packet, other than the first part, is to be transmitted, and wherein to cause the UE to selectively transmit the second part of the uplink packet, the processing system is configured to cause the UE to:
refrain from transmitting the second part of the uplink packet.

13. The UE of claim 1, wherein the first part of the uplink packet includes uplink control information (UCI), separate from the first portion of the data, that includes the control information, and wherein the UCI is associated with a cyclic redundancy check (CRC) specific to the UCI.

14. The UE of claim 1, wherein the control information is embedded with the first portion of the data in a payload of the first part of the uplink packet.

15. The UE of claim 1, wherein the processing system is configured to cause the UE to:
receive a UE-specific acknowledgement (ACK) indicative of successful decoding of all parts of the uplink packet, wherein the UE-specific ACK is received via:
downlink control information (DCI) scrambled by a user identifier (ID) associated with the UE,
group common DCI (GC-DCI) with a payload including a UE ID associated with the UE, or
GC-DCI including an ACK or negative acknowledgment (NACK) (ACK/NACK) bit mapped to a resource ID associated with a resource pool.

16. The UE of claim 1, wherein to cause the UE to selectively transmit the second part of the uplink packet, the processing system is configured to cause the UE to transmit the second part of the uplink packet, and wherein the processing system is configured to cause the UE to:
receive feedback indicative of successful decoding of the first part and unsuccessful decoding of the second part; and
retransmit the second part based at least in part on the feedback,
wherein the feedback includes:
a negative acknowledgement (NACK), received via downlink control information (DCI) or group common DCI (GC-DCI), that indicates information associated with the second part,
a retransmission grant received via DCI scrambled by a user identifier (ID) associated with the UE, or
a NACK, indicated in GC-DCI, via an acknowledgment (ACK) or NACK (ACK/NACK) bit mapped to a resource ID associated with a resource pool.

17. The UE of claim 1, wherein the processing system is configured to cause the UE to:
receive feedback indicative of successful decoding of the control information and unsuccessful decoding of at least one of the first portion of the data or the second part; and
retransmit the at least one of the first portion of the data or the second part based at least in part on the feedback,
wherein the feedback includes:
a negative acknowledgement (NACK), received via downlink control information (DCI) or group common DCI (GC-DCI), that indicates information associated with the at least one of the first portion of the data or the second part,
a retransmission grant received via DCI scrambled by a user identifier (ID) associated with the UE, or
a NACK, indicated in GC-DCI, via an acknowledgment (ACK) or NACK (ACK/NACK) bit mapped to a resource ID associated with a resource pool.

18. The UE of claim 1, wherein the processing system is configured to cause the UE to:
retransmit the first part of the uplink packet, and selectively retransmitting the second part of the uplink packet, in connection with a determination that no acknowledgment (ACK) or negative acknowledgment (NACK) (ACK/NACK) feedback associated with the uplink packet has been received.

19. A network node, comprising:
a processing system that includes one or more processors and one or more code-storing memories coupled with the one or more processors, the processing system configured to cause the network node to:
transmit configuration information indicating resources for multipart uplink packet transmission;
receive, based on blind decoding in a first set of resources of the resources for multipart uplink packet transmission, a first part of an uplink packet associated with a UE, wherein the first part includes control information and a first portion of data of the uplink packet; and
selectively receive, based on the control information, a second part of the uplink packet associated with the UE, wherein the second part includes a second portion of the data of the uplink packet.

20. A method of wireless communication performed by a user equipment (UE), comprising:
receiving configuration information indicating resources for multipart uplink packet transmission;
transmitting a first part of an uplink packet in accordance with the configuration information, wherein the first part includes control information and a first portion of data of the uplink packet; and
selectively transmitting a second part of the uplink packet in accordance with the configuration information, wherein the second part includes a second portion of the data of the uplink packet.
